(19) United States
(12) Patent Application Publication
(10) Pub. No.: US 2019/0251506 A1
(43) Pub. Date: Aug. 15, 2019

(54) SYSTEM, METHOD, AND APPARATUS FOR DETERMINING AND CORRECTING SHIPPING VOLUMES

(71) Applicant: Panjiva, Inc., New York, NY (US)

(72) Inventors: Peter Goodings Swartz, Cambridge, MA (US); Hanna Simona Kipnis King, Cambridge, MA (US); Timothy George Garnett, San Mateo, CA (US); James Ryan Psota, Cambridge, MA (US)

(21) Appl. No.: 16/159,584

(22) Filed: Oct. 12, 2018

Related U.S. Application Data
(60) Provisional application No. 62/571,720, filed on Oct. 12, 2017.

(51) Int. Cl. G06Q 10/08; G06F 16/215; G06F 16/21; G06F 16/23

(52) U.S. Cl. CPC G06Q 10/0838; G06F 16/2365; G06F 16/219; G06F 16/215

(57) ABSTRACT

Systems and methods for processing shipping records are described. A system includes a record access circuit structured to interpret a plurality of records, each including multiple shipment description values. A container representation circuit is structured to determine a container volume value corresponding to each of the plurality of records, and to further determine the container volume value in response to a weighting between the shipment description values. A shipping volume reporting circuit is structured to update each of the records with the container volume value. A related method includes interpreting a plurality of records, each record including multiple shipment description values. The method includes determining a container volume value corresponding to each of the records, in response to a weighting between the shipment description values, and updating each of the plurality of records with the container volume value.

### CROSS REFERENCE TO RELATED APPLICATION

This application claims the benefit of and priority to U.S. Provisional Patent Application No. 62/571,720, filed Oct. 12, 2017, the entire contents of which are incorporated herein by reference.

### TECHNICAL FIELD

This disclosure is related to determining and correcting shipping volumes.

### BACKGROUND

Presently known systems for determining and correcting shipping volumes suffer from a number of drawbacks. Shipping records often have incorrect or incomplete data, and reliable shipping volumes are difficult to determine with presently known systems.

### SUMMARY

There is therefore a need for systems and methods for accurately determining and correcting shipping volumes.

In one aspect, the technology features a system including a record access circuit structured to interpret a plurality of records, each of the records comprising a plurality of shipment description values. The system includes a container representation circuit structured to determine a container volume value corresponding to each of the plurality of records, wherein the container representation circuit is further structured to determine the container volume value in response to a weighting between the shipment description values. The system includes a shipping volume reporting circuit structured to update each of the plurality of records with the container volume value.

In some embodiments, the system includes a record filtering circuit structured to interpret a second plurality of records, wherein the second plurality of records comprises the plurality of records, to filter the second plurality of records in response to a container identifier corresponding to each of the second plurality of records, and to provide the plurality of records to the record access circuit as a set of records having a common container identifier. In some embodiments of the system, the container identifier comprises a primary key for a container. In some embodiments of the system, the record filtering circuit is further structured to determine the container identifier corresponding to each of the second plurality of records in response to at least one value selected from the values consisting of: a container number value, a corrected container number value, and a container number value determined from a container number clean-up operation.

In some embodiments, the system determines that a first container having a first container number value identical to a second container having a second container number value is a distinct physical container, and providing a first container identifier for the first container and a second container identifier for the second container. In some embodiments of the system, the shipment description values comprise at least one value selected from the values consisting of: a geometric description value, an equipment code value, a container category identifier, and a previously known value for any of the preceding corresponding to the container identifier.

In some embodiments of the system, the container representation circuit is further structured to determine the container volume value in response to the weighting between the shipment description values by performing at least one operation selected from the operations selected from determining a container attribute vote value corresponding to each of the plurality of records, and selecting the container volume value in response to the container attribute vote values, determining a container attribute vote value corresponding to each of the plurality of records, and selecting the container volume value in response to the container attribute vote values according to the most commonly appearing container volume value and determining a container attribute vote value corresponding to each of the plurality of records, determining a source quality value corresponding to each of the container attribute vote values, and selecting the container volume value in response to the container attribute vote values and corresponding source quality values.

The above aspects can include one or more of the following features. In some embodiments, the container representation circuit is further structured to determine the container volume value in response to the weighting between the shipment description values by determining a container attribute vote value corresponding to each of the plurality of records and further in response to a highest source quality value from a plurality of volume sources within each of the plurality of records, and selecting the container volume value in response to the container attribute vote values and corresponding source quality values.

In some embodiments, the container representation circuit is further structured to determine the container volume value in response to the weighting between the shipment description values by determining a container attribute vote value corresponding to each of a plurality of volume sources within each of the plurality of records, and selecting the container volume value in response to the container attribute vote values.

In some embodiments, the container representation circuit is further structured to determine the container volume value in response to the weighting between the shipment description values by determining a source quality value corresponding to each of the container attribute vote values, and further selecting the container volume value in response to the container attribute vote values.

In some embodiments, the container attribute vote values are restricted to a discrete number of predetermined container attribute values. In some embodiments, the container attribute vote values comprise container volume vote values. In some embodiments, the container representation circuit is further structured to determine the container volume value in response to the weighting between the shipment description values by utilizing, in order: container attribute vote values corresponding to geometric description values; container attribute vote values corresponding to equipment code values; and container attribute values corresponding to equipment category identifier values.

In some embodiments, the container representation circuit is further structured to determine the container volume value in response to the weighting between the shipment description values by performing a rationalization operation on the container volume value. In some embodiments, the container representation circuit is further structured to determine the container volume value in response to the weighting between the shipment description values by averaging a plurality of the container attribute vote values. In some embodiments, the averaging comprises utilizing at least one of a mode value from the plurality of container attribute vote values, a median value from the plurality of container attribute vote values, or a mean value from the plurality of container attribute vote values.

In some embodiments, the container representation circuit is further structured to determine the container volume value in response to the weighting between the shipment description values by utilizing at least one value selected from the values consisting of: a default container volume value, a previously utilized container volume value corresponding to a container identifier corresponding to the plurality of records, and an indirectly determined container volume value. In some embodiments, the container representation circuit is further structured to determine the indirectly determined container volume value by performing at least one operation selected from the operations consisting of a determination of a material type value and a shipping weight value, and a volume correlation between a product category system and a weight of the shipment.

In some embodiments, the product category system includes at least one system selected from the systems consisting of harmonized system (HS) codes, chemical abstracts service (CAS) numbers, an industry specific code, an entity specific code, a text description, an entity value, a listed weight value, a shipping vessel utilized, and a port utilized.

In some embodiments, the container representation circuit is further structured to determine that a container is divided, and to attribute a portion of the container volume value to each of a plurality of the plurality of records. In some embodiments, the container representation circuit is further structured to determine that a container is divided, and to perform at least one of the following operations in response to the divided container: attribute a record count fraction of the plurality of records associated with the divided container to each of a plurality of at least one of entities and transactions, attribute a weight value fraction of each the plurality of records associated with the divided container, and attribute a volume fraction of each of the plurality of records associated with the divided container.

In some embodiments, the container volume value is restricted to a discrete number of predetermined container volume values. In some embodiments, the predetermined container volume values comprise integer values of twenty-foot equivalent units (TEU). In some embodiments, the predetermined container volume values comprise half-integer values of twenty-foot equivalent units (TEU).

In some embodiments, the system includes a data integrity circuit structured to perform an attribute cleanup operation on at least one shipping description value of one of the plurality of records before determining the container attribute vote value utilizing the at least one shipping description value.

In some embodiments, the attribute cleanup operation comprises at least one operation selected from: determining an internal consistency of the at least one shipping description value in response to other shipping description values of the one of the plurality of records, determining the at least one shipping description value corresponds to a standardized value, determining the at least one shipping description value includes at least one of an incorrect units value and an improperly converted units value, determining the at least one shipping description value includes a predetermined error attribute, determining the at least one shipping value includes an extraneous character, and determining an external consistency of the at least one shipping description value in response to at least one of: other shipping description values within the one of the plurality of records, a same shipping description value within a distinct one of the plurality of records, and other shipping description values within a distinct one of the plurality of records. In some embodiments, the attribute cleanup operation includes adjusting a weighting of the container attribute vote value utilizing the at least one shipping description value in response to at least one of a type of the attribute cleanup operation and a quantitative assessment of the attribute cleanup operation.

In some embodiments, the system includes a data integrity circuit structured to adjust a weighting of at least one of the container attribute vote values in response to at least one data quality indicator selected from the data quality indicators consisting of: a shipping description value source type, an entity associated with the one of the plurality of records including the shipping description value utilized to determine the container attribute vote, a consistency indicator determined for the one of the plurality of records including the shipping description value utilized to determine the container attribute vote, a geography value corresponding to the one of the plurality of records including the shipping description value utilized to determine the container attribute vote, and combinations of the foregoing.

In some embodiments, the container representation circuit is further structured to adjust a change rate of at least one of a container attribute value or the container volume value in response to an apparent rate of change of the container attribute value or the container volume value. In some embodiments, the container representation circuit is further structured to adjust the change rate of at least one of a container attribute value or the container volume value by allowing a rapid change in response to at least one of: determining that an apparent change improves the precision of the at least one of the container attribute value or the container volume value, determining that an apparent change in the at least one of the container attribute value or the container volume value is indicated with high reliability, and determining that an apparent change in the at least one of the container attribute value or the container volume value reflects an actual change in a container corresponding to the at least one of the container number value or the container identifier.

In some embodiments, the container representation circuit is further structured to adjust the change rate of at least one of the container attribute value or the container volume value by slowing a change in response to at least one of: determining that an apparent change results in a categorical change in a container corresponding to at least one of the container number value or the container identifier, determining that an apparent change results in a changed container volume value corresponding to the container identifier, and determining that an apparent change in the at least one of the container attribute value or the container volume value reflects an actual change in a container corresponding to the at least one of the container number value or the container value, where the actual change is not supported in an available data set comprising the plurality of records.

In some embodiments, the container representation circuit is further structured to exclude consideration for at least one of the plurality of records in response to determining the one of the plurality of records does not represent data indicative of a physical container corresponding to at least one of the container number value or the container identifier. In some embodiments, the shipping volume reporting circuit is further structured to create or amend a shipping record in response to the container volume value. In some embodiments, the shipping volume reporting circuit is further structured to associate a container identifier to the shipping record, and to provide a plurality of container attribute values corresponding to the container identifier. In some embodiments, the shipping volume reporting circuit is further structured to provide an aggregated shipping record comprising an aggregated shipping value determined in response to a plurality of the shipping records.

In some embodiments, the aggregated shipping record includes an aggregation of the shipping records corresponding to at least one of: an entity, a geographic location, a product type, a shipping vehicle, and at least one container identifier. In some embodiments, the aggregated shipping record comprises a volumetric description value.

In another aspect, the technology features a method including steps for interpreting a plurality of records, each of the records comprising a plurality of shipment description values, determining a container volume value corresponding to each of the plurality of records, in response to a weighting between the shipment description values, and updating each of the plurality of records with the container volume value.

In some embodiments, the method includes interpreting a second plurality of records, wherein the second plurality of records comprises the plurality of records, filtering the second plurality of records in response to a container identifier corresponding to each of the second plurality of records, and providing the plurality of records as a set of records having a common container identifier. In some embodiments, the container identifier comprises a primary key for a container. In some embodiments, the method includes determining the container identifier corresponding to each of the second plurality of records in response to at least one value selected from the values consisting of: a container number value, a corrected container number value, and a container number value determined from a container number clean-up operation.

In some embodiments, the method includes determining that a first container having a first container number value identical to a second container having a second container number value is a distinct physical container, and providing a first container identifier for the first container and a second container identifier for the second container. In some embodiments, the shipment description values comprise at least one value selected from the values consisting of: a geometric description value, an equipment code value, a container category identifier, and a previously known value for any of the preceding corresponding to the container identifier.

In some embodiments, the method includes determining the container volume value in response to the weighting between the shipment description values by performing at least one operation selected from the operations selected from: determining a container attribute vote value corresponding to each of the plurality of records, and selecting the container volume value in response to the container attribute vote values, determining a container attribute vote value corresponding to each of the plurality of records, and selecting the container volume value in response to the container attribute vote values according to the most commonly appearing container volume value, and determining a container attribute vote value corresponding to each of the plurality of records, determining a source quality value corresponding to each of the container attribute vote values, and selecting the container volume value in response to the container attribute vote values and corresponding source quality values.

In some embodiments, the method includes determining the container volume value in response to the weighting between the shipment description values by: determining a container attribute vote value corresponding to each of the plurality of records and further in response to a highest source quality value from a plurality of volume sources within each of the plurality of records, and selecting the container volume value in response to the container attribute vote values and corresponding source quality values. In some embodiments, the method includes determining the container volume value in response to the weighting between the shipment description values by: determining a container attribute vote value corresponding to each of a plurality of volume sources within each of the plurality of records, and selecting the container volume value in response to the container attribute vote values.

In some embodiments, the method includes determining the container volume value in response to the weighting between the shipment description values by determining a source quality value corresponding to each of the container attribute vote values, and further selecting the container volume value in response to the container attribute vote values. In some embodiments, the method includes restricting the container attribute vote values to a discrete number of predetermined container attribute values. In some embodiments, the container attribute vote values comprise container volume vote values.

In some embodiments, the method includes determining the container volume value in response to the weighting between the shipment description values by utilizing, in order: container attribute vote values corresponding geometric description values, container attribute vote values corresponding to equipment code values, and container attribute values corresponding to equipment category identifier values. In some embodiments, the method includes determining the container volume value in response to the weighting between the shipment description values by performing a rationalization operation on the container volume value.

In some embodiments, the method includes determining the container volume value in response to the weighting between the shipment description values by averaging a plurality of the container attribute vote values. In some embodiments, the averaging comprises utilizing at least one of: a mode value from the plurality of container attribute vote values, a median value from the plurality of container attribute vote values, or a mean value from the plurality of container vote values. In some embodiments, the method includes determining the container volume value in response to the weighting between the shipment description values by utilizing at least one value selected from the values consisting of: a default container volume value, a previously utilized container volume value corresponding to a container identifier corresponding to the plurality of records, and an indirectly determined container volume value.

In some embodiments, the method includes determining the indirectly determined container volume value by performing at least one operation selected from the operations consisting of: determining a material type value and a shipping weight value, and determining a volume correlation between a harmonized system (HS) code and a weight of the shipment. In some embodiments, the method includes determining that a container is divided, and attributing a portion of the container volume value to each of a plurality of the plurality of records. In some embodiments, the method includes determining that a container is divided, and performing at least one of the following operations in response to the divided container: attributing a record count fraction of the plurality of records associated with the divided container to each of a plurality of at least one of entities and transactions, attributing a weight value fraction of each the plurality of records associated with the divided container, and attributing a volume fraction of each of the plurality of records associated with the divided container.

In some embodiments, the method includes restricting the container volume value to a discrete number of predetermined container volume values. In some embodiments, the predetermined container volume values comprise integer values of twenty-foot equivalent units (TEU). In some embodiments, the predetermined container volume values comprise half-integer values of twenty-foot equivalent units (TEU). In some embodiments, the method includes performing an attribute cleanup operation on at least one shipping description value of one of the plurality of records before determining the container attribute vote value utilizing the at least one shipping description value.

In some embodiments, the attribute cleanup operation comprises at least one operation selected from: determining an internal consistency of the at least one shipping description value in response to other shipping description values of the one of the plurality of records, determining the at least one shipping description value corresponds to a standardized value, determining the at least one shipping description value includes at least one of an incorrect units value and an improperly converted units value, determining the at least one shipping description value includes a predetermined error attribute, determining the at least one shipping value includes an extraneous character, and determining an external consistency of the at least one shipping description value in response to at least one of: other shipping description values within the one of the plurality of records, a same shipping description value within a distinct one of the plurality of records, and other shipping description values within a distinct one of the plurality of records.

In some embodiments, the method includes adjusting a weighting of the container attribute vote value utilizing the at least one shipping description value in response to at least one of a type of the attribute cleanup operation and a quantitative assessment of the attribute cleanup operation. In some embodiments, the method includes adjusting a weighting of at least one of the container attribute vote values in response to at least one data quality indicator selected from the data quality indicators consisting of: a shipping description value source type, an entity associated with the one of the plurality of records including the shipping description value utilized to determine the container attribute vote, a consistency indicator determined for the one of the plurality of records including the shipping description value utilized to determine the container attribute vote, a geography value corresponding to the one of the plurality of records including the shipping description value utilized to determine the container attribute vote, and combinations of the foregoing.

In some embodiments, the method includes adjusting a change rate of at least one of a container attribute value or the container volume value in response to an apparent rate of change of the container attribute value or the container volume value. In some embodiments, the method includes adjusting the change rate of at least one of a container attribute value or the container volume value by allowing a rapid change in response to at least one of: determining that an apparent change improves the precision of the at least one of the container attribute value or the container volume value, determining that an apparent change in the at least one of the container attribute value or the container volume value is indicated with high reliability, and determining that an apparent change in the at least one of the container attribute value or the container volume value reflects an actual change in a container corresponding to the at least one of the container number value or the container identifier.

In some embodiments, the method includes adjusting the change rate of at least one of the container attribute value or the container volume value by slowing a change in response to at least one of: determining that an apparent change results in a categorical change in a container corresponding to at least one of the container number value or the container identifier, determining that an apparent change results in a changed container volume value corresponding to the container identifier, and determining that an apparent change in the at least one of the container attribute value or the container volume value reflects an actual change in a container corresponding to the at least one of the container number value or the container value, where the actual change is not supported in an available data set comprising the plurality of records. In some embodiments, the method includes excluding from consideration at least one of the plurality of records in response to determining the one of the plurality of records does not represent data indicative of a physical container corresponding to at least one of the container number value or the container identifier.

In some embodiments, the method includes creating a shipping record in response to the container volume value. In some embodiments, the method includes associating a container identifier to the shipping record, and providing a plurality of container attribute values corresponding to the container identifier. In some embodiments, the method includes providing an aggregated shipping record comprising an aggregated shipping value determined in response to a plurality of the shipping records. In some embodiments, the aggregated shipping record comprises an aggregation of the shipping records corresponding to at least one of: an entity, a geographic location, a product type, a shipping vehicle, and at least one container identifier. In some embodiments, the aggregated shipping record comprises a volumetric description value.

### BRIEF DESCRIPTION OF THE DRAWINGS

The advantages of the systems and methods described herein, together with further advantages, may be better understood by referring to the following description taken in conjunction with the accompanying drawings. The drawings are not necessarily to scale, emphasis instead generally being placed upon illustrating the principles of the described embodiments by way of example only.

FIG. 1 is a block diagram of a system according to embodiments of the technology described herein.

FIG. 2 shows an exemplary diagram of records according to embodiments of the technology described herein.

FIG. 3 shows examples of shipment values according to embodiments of the technology described herein.

FIG. 4 shows an exemplary container representation circuit according to embodiments of the technology described herein.

FIG. 5 shows an exemplary record according to embodiments of the technology described herein.

FIG. 6 shows examples of volume sources within a record according to embodiments of the technology described herein.

FIG. 7 is a block diagram of a system according to embodiments of the technology described herein.

FIG. 8 is a block diagram of a system according to embodiments of the technology described herein.

FIG. 9 is a block diagram of a system according to embodiments of the technology described herein.

FIG. 10 shows an exemplary aggregated shipping record according to embodiments of the technology described herein.

FIG. 11 is a block diagram of a system according to embodiments of the technology described herein.

FIG. 12 is a flow diagram of an exemplary procedure for determining a container volume and providing a shipping record made in response to the container volume according to embodiments of the technology described herein.

FIG. 13 is a flow diagram of an exemplary procedure according to embodiments of the technology described herein.

FIG. 14 is a flow diagram of an exemplary procedure for determining a container identifier corresponding to each of the records in response to a container number value according to embodiments of the technology described herein.

FIG. 15 is a flow diagram of an exemplary procedure for matching records having a shared container number value, and/or distinguishing distinct physical containers having a shared container number value according to embodiments of the technology described herein.

FIG. 16 is a flow diagram of an exemplary procedure for determining the container volume value in response to the weighting between the shipment description values according to embodiments of the technology described herein.

FIG. 17 is a flow diagram of an exemplary procedure for determining the container volume value in response to the weighting between the shipment description values according to embodiments of the technology described herein.

FIG. 18 is a flow diagram of an exemplary procedure for determining a container volume value according to embodiments of the technology described herein.

FIG. 19 is a flow diagram of an exemplary procedure for determining an uncontainerized volume for one or more records according to embodiments of the technology described herein.

FIG. 20 is a flow diagram of an exemplary procedure for utilizing container attribute values to determine a container volume value according to embodiments of the technology described herein.

FIG. 21 shows an exemplary aggregated shipping record according to embodiments of the technology described herein.

### DETAILED DESCRIPTION

Certain system and operations described throughout the present disclosure provide for determining shipping volumes related to entities (e.g., shippers, consignees, delivery targets, etc.) and/or facilities (e.g., ports, shipping vessels, supply chain members contributing to an entity or set of entities, etc.). Additionally or alternatively, systems and operations described throughout the present disclosure provide for determining aggregated shipping values such as financial value, weight, utilization, and other parameters determinable utilizing volumetric shipping information, with example users including port managers and/or entities considering which ports to utilize and when, financial analysts (e.g., valuating shipments, confirming sales or volumes, performing due diligence on entities), customs officials and/or law enforcement (e.g., determining anomalous shipments or shipping trends), assessment and/or tracking of competitors, assessment and/or tracking of internal shipping data or supply chains, and/or sizing of industry segments (e.g., for market analysis, economic macro data, determining types of goods). In certain embodiments, the tracking of shipment volumes to determine trends (e.g., the rate of change of shipment volumes) is subject to high noise values, and thus accurate determination of shipping volumes is even more important when looking for trends or rates of change in shipping volumes. In certain embodiments, the determination of shipping volumes against threshold values also makes accurate determinations desirable—for example if a shipping volume is near a threshold (e.g., with respect to a contractual target, a potentially flagged volume to detect an anomaly, etc.) then the determination of whether the threshold is met or not relies upon highly accurate data, where loss of accuracy results in an improper decision (e.g., determining a threshold is crossed when it is not) and/or longer-term statistical analysis to ensure a high confidence that the threshold is met (e.g., resulting in delays in decision making, loss of rights or the ability to respond, etc.). Additionally, high resolution data analytics, such as determining small changes within a large data set, benefit from improved data accuracy both to detect the information sought from the data, and to be able to pull such information out both quickly (e.g., without time delay) and with high confidence.

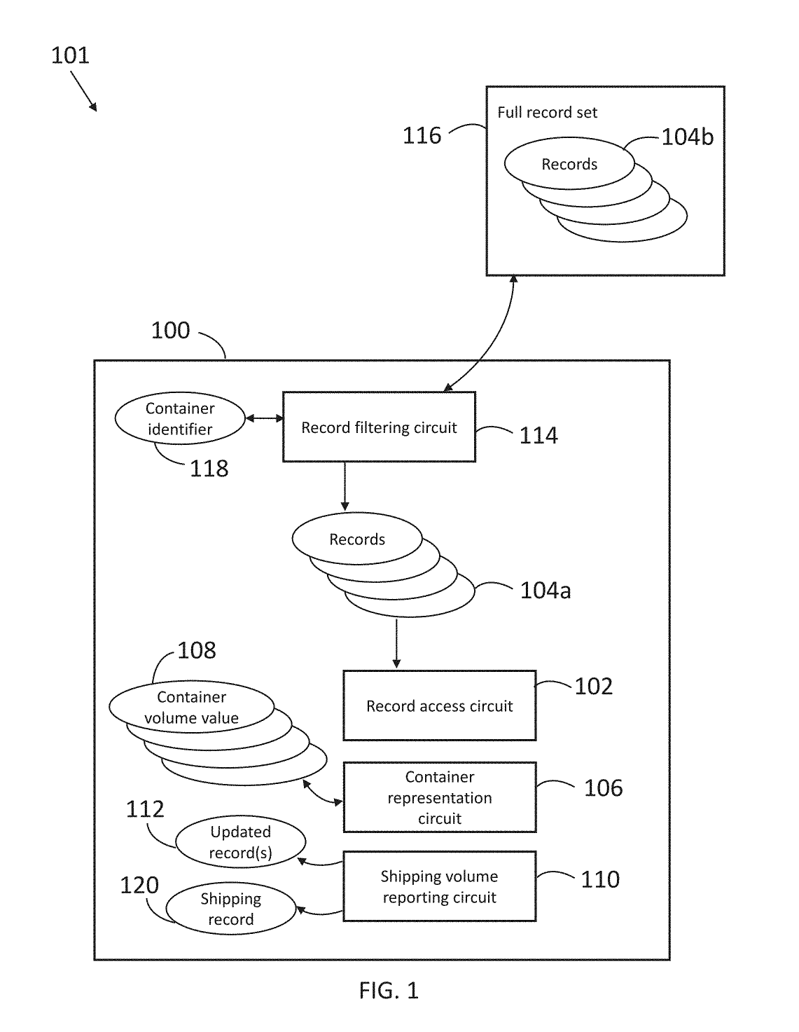

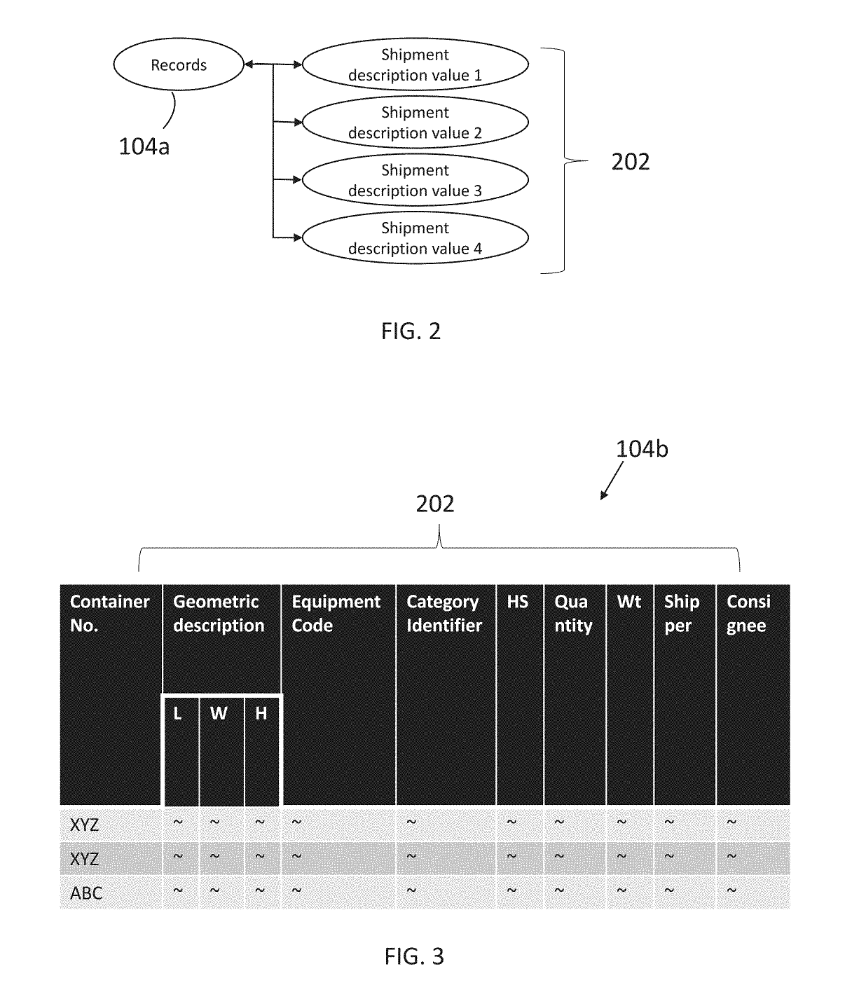

Referencing FIG. 1, a diagram 101 shows an example system 100 including a record access circuit 102 that interprets a number of records 104, each of the records 104 including a number of shipment description values 202 (reference FIG. 2). Example and non-limiting record access circuit 102 devices include a server accessing the records 104a from a memory location within a computing device including the record access circuit 102 and/or over a network, the internet, or other remote accessing system, an application programming interface (API) accessing the records 104a from a storage location, server, cloud storage application, a web based application accessing the records 104a, and/or the record access circuit 102 may store the records 104a and act as a server of the records 104a to the container representation circuit 106 or other aspects of the system 100. In certain embodiments, the record access circuit 102 stores the records 104a, stores a portion of the records 104a and accesses a remainder of the records 104a during operations of the system 100, and/or periodically refreshes the records 104a. In certain embodiments, the record access circuit 102 accesses the records 104a each time the system 100 operates and utilizes the records 104a.

Example records 104 include customs data records, shipping information records, transactions for shipping events, and/or similar records indicating shipped goods and information related to the shipped goods. The records 104 are depicted as a first number of records 104a determined from a full record set 116, for example where the full record set 116 includes the records 104b, which may be stored separately from the records 104a, or may be the same data accessed within the full record set 116, such as by pointers, virtual referencing, or the like. In certain embodiments, the records 104a may be stored locally, for example on a local server (not shown) separate from the storage location of the full record set 116, within a separate memory space on a same computing device that stores the full record set 116 (e.g., in a separate memory address within the same computing system; within RAM at run-time, where the full record set 116 is stored in a non-volatile memory; and/or on a separate computing device from the computing device storing the full record set 116). The full record set 116 and the records 104a, 104b are depicted as separated for convenience of description and to illustrate the logical separation of the records 104a, 104b, 116. In certain embodiments, records within a given record set may be divided across computing devices (e.g., in a cloud storage space where the location of the records 104a, 104b, 116 is not known or important), and/or records 104a, 104b, 116 may include wholly or partially shared physical memory locations. In certain embodiments, records 104a are present in the system 100, but one or more of records 104b, 116 are not present within the system 100.

The example system 100 further includes a container representation circuit 106 that determines a container volume value 108 corresponding to each of the records 104a, such as determining the container volume value 108 in response to a weighting between the shipment description values 202. The term “weighting” as utilized herein should be understood broadly. Example and non-limiting operations and features contemplated by weighting as used herein include, without limitation: applying contributions from certain members of the weighted class differentially based upon criteria determined to indicate that such members are more indicative of the determined value and/or that such members are more likely to have a correct indication of the determined value; applying contributions from certain members or member types of the weighted class before applying contributions from other members or member types of the weighted class; increasing or decreasing a number of votes contributed by a voting member of a weighted class; increasing or decreasing a rate of change of a determined value according to certain members or member types indicating that the determined value has changed; allowing certain member or member types of the weighted class to determine (e.g., excluding considerations from other members or member types of the weighted class) an indicated value; and/or excluding certain members or member types of the weighted class from consideration to determine an indicated value. Certain considerations for determining the type (qualitative) and amount (quantitative) of weighting to apply to members or member types of a weighted class include, without limitation: a reliability of the data member based on intrinsic (e.g., does the member or member type appear to be valid, within expected ranges, etc.) or extrinsic (e.g., is an entity that entered the data for the data member historically enter valid data; is the data entered in a geographic region that historically enters valid data for the type of data being considered; do industry practices related to the data member historically provide valid data for the type of data being considered; is the data member complex and typically entered by hand, and prone to errors; etc.) information about the member or member type of the data; the type, number, and/or reliability of clean-up operations performed on the data before utilization in the weighted class; and/or the relationship of the data being considered relative to historical or expected values for the data. One of skill in the art, having the benefit of the disclosures herein, can readily determine weighting schemes and weighting values for weighted determinations herein having information ordinarily available when contemplating a particular system for determining shipping volumes and aggregated shipping information.

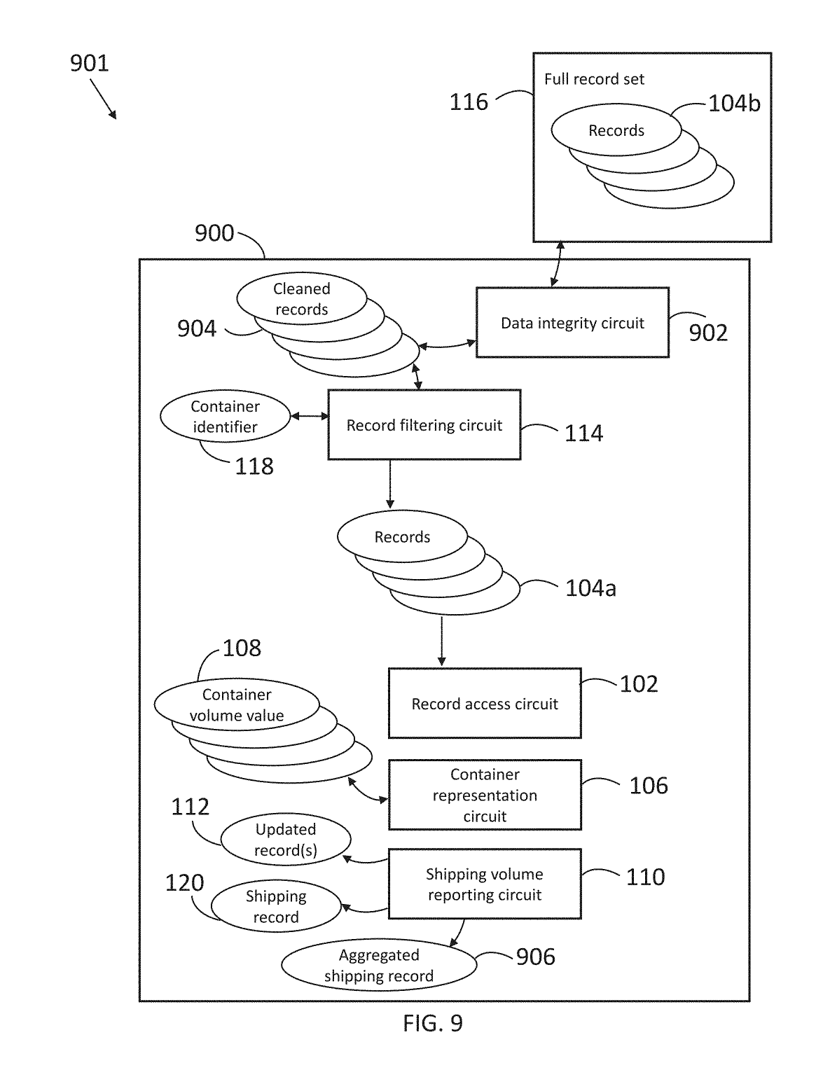

The example system 100 further includes a shipping volume reporting circuit 110 that updates each of the plurality of records 104a, 104b (depicted as updated records 112 in the example of FIG. 1) with the container volume value 108. The example shipping volume reporting circuit 110 describes updating the records, however the shipping volume reporting circuit 110, in certain embodiments, additionally or alternatively utilizes the container volume value(s) 108 to provide a shipping record 120, and/or to provide other information such as an aggregated shipping record 906 (see the description referencing FIG. 9). The container volume value(s) 108 may be stored for future use, associated with a container identifier 118 in a separate canonical representation of the related container, and/or deleted after the provision of the shipping record 120 and/or updated records 112. Non-limiting examples of an updated record 112 include: an amended version of the records 104a and/or 104b; an appended version of the records 104a and/or 104b; and/or a separate record 112 having the container volume value 108 as a field therein available for future retrieval and further operations. Non-limiting examples of a shipping record 120 include: a data export of the full record set 116 and/or records 104a, 104b filtered by a parameter of interest (e.g., shipping related to certain dates, entities, geographic locations, categories of goods, types of containers, etc.); a sequenced set of shipping data such as a bar graph or other data visualization (e.g., shipping volumes versus time, shipping by entity, shipping by categories of goods); and/or an aggregated shipping record 906 (e.g., shipping volumes according to dates, entities, geographic locations, categories of goods, type of containers, etc.) such as totals, grouped totals, and the like.

An example system 100 includes a record filtering circuit 114 that interprets a second number of records 116, for example a full record set 116. The example system 100 depicts a full record set 116, which may already be filtered from a larger data set. For example, the full record set 116 may be a set of transaction records over the last 5 years, 3 years, or other selected time frame, a set of transaction records for a particular port, etc. The full record set 116 includes any record set created for any purpose that has not yet been intentionally reduced by identification of individual containers (e.g., container numbers or other container identifiers 118), although the full record set 116 may be filtered, in certain embodiments, by criteria that tend to affect the container numbers found in the full record set 116 (e.g., including/excluding container numbers having a particular number or sequence of numbers included therein, including/excluding certain container type values, including/excluding certain entities related to the records 116, etc.). The record filtering circuit 114 performs operations to filter the full record set 116 to the records 104a, for example including a number of records from the full record set 116 that are related to a particular container identifier 118. An example container identifier 118 is a canonical unique value for a given container—such as a primary key associated with the container and stored by the system 100 for future use and/or further operations. An example record filtering circuit 114 checks the characteristics of a container in the records 116, 104b, creating a new container identifier 118 if no container identifier 118 already exists for the container, and utilizing a previous container identifier 118, including potentially adding the container identifier 118 as a field into the records 104b. For example, if a previous container identifier 118 already exists, a new record (e.g., a received record added to 104b) may be used to update the container volume value or other characteristic information of the container, for example based upon the weighting of the new records information combined with previous records already associated with the container identifier 118. The container identifier 118, in certain embodiments, is a hidden field that is not displayed to a user (not shown) or provided in the updated records 112 and/or shipping record 120. In certain embodiments, the container identifier 118 is displayed to a user and/or provided in the updated records 112 and/or shipping record 120. In certain embodiments, the container identifier 118 matches a container number and/or a corrected container number. Additionally or alternatively, the container identifier 118 is a forced unique value for each container, and/or a newly created unique value (e.g., where two distinct physical containers share a same container number for any reason, such as the re-use of a container number by an entity, and/or a collision of container numbers through error or containers happening to have the same container number in two separate numbering systems external to the system 100). The example record filtering circuit 114 provides the records 104b to the record access circuit 102 as a set of records having a common container identifier 118. In certain embodiments, the record filtering circuit 114 provides sequential sets of records 104b to the record access circuit 102, each grouped by a container identifier 118, and/or provides a set of records 104b having multiple containers therein, wherein the record access circuit 102 and other aspects of the system 100 are configured to operate on the records 104b in view of the container identifier 118 within the records 104b.

An example record filtering circuit 114 further determines the container identifier 118 corresponding to each of the full record set 116 and/or records 104b in response to at least one value such as: a container number value, a corrected container number value, and/or a container number value determined from a container number clean-up operation. For example, records 116, 104b include a container number having errors, extraneous characters, or the like, which are nevertheless recognizable and associated with a corrected container number value (e.g., stored as a separate corrected field, represented as a change to the actual container number field, and/or utilized during run-time operations to create the container identifier).

An example system 100 includes an operation (e.g., by the record filtering circuit 114, the container representation circuit 106, and/or a data integrity circuit 902—see the description referencing FIG. 9) to determine that a first container having a first container number value identical to a second container having a second container number value is a distinct physical container, and to provide a first container identifier 118 for the first container and a second container identifier 118 for the second container. An example system 100 includes the shipment description values 202 including values such as: a geometric description value (e.g., a length, height, and/or width measurement), an equipment code value (e.g., an industry or government created standard code value, such as found at https://www.cbp.gov/sites/default/files/documents/appendix_m_3.doc, last visited 18 Jul. 2017, and/or in accordance with an industry standard such as ISO 6346), a container category identifier (e.g., an equipment category identifier such as in accordance with ISO 6346), and/or a previously known value for any of the preceding corresponding to the container identifier 118. The example shipment description values 202 are non-limiting examples, and any values tending to identify a physical container individually and/or any values tending to provide information describing or that can be correlated to a volume of the container may be included in certain embodiments as a shipment description value 202. The shipment description values 202 further include, in certain embodiments, any data of interest related to a transaction, for example entities, shippers, consignees, materials (e.g., material description; harmonized standard (HS) codes; weights, values, and/or amounts of goods), dates related to the record, geographic information related to the record, and/or any other information such as information that may be utilized to aggregate records and/or provided as context for an updated record 112 and/or a shipping record 120.

Referencing FIG. 2, an example record 104a includes a number of shipping description values, generically depicted as “shipment description value 1” through “shipment description value 4.” Referencing FIG. 3, example and non-limiting shipment description values 202 are shown in a table illustration of a record or a number of records, including the container number, geometric description values, an equipment code, a category identifier, an HS code, a quantity description, a weight, a shipper listing, and a consignee listing. Each row of the table in FIG. 3 may represent a record and/or a portion of a record (e.g., where a record includes multiple shipping elements listed therein).

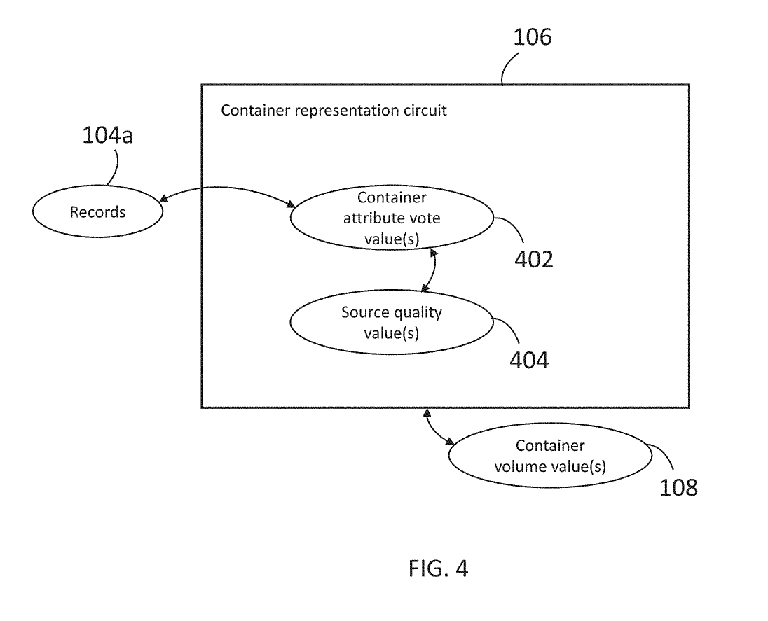

Referencing FIG. 4, an example container representation circuit 106 further determines the container volume value 108 in response to the weighting between the shipment description values 202 by performing at least one operation such as: determining a container attribute vote value 402 corresponding to each of the records 104a, and selecting the container volume value 108 in response to the container attribute vote values 402; determining a container attribute vote value 402 corresponding to each of the records 104a, and selecting the container volume value 108 in response to the container attribute vote values 402 according to the most commonly appearing container volume value and/or container attribute value; and determining a container attribute vote value 402 corresponding to each of the records 104a, determining a source quality value 404 corresponding to each of the container attribute vote values 402, and selecting the container volume value 108 in response to the container attribute vote values 402 and corresponding source quality values 404. For example, a container attribute vote value 402 may be a shipping description value 202 within a record 104a tending to indicate a volume of the container, such as a geometric description value (e.g., a length of the container). In certain embodiments, the container attribute vote values 402 are aggregated from the records 104a to determine the actual container attribute most likely for the container, and the container volume value 108 is then determined from the actual container attribute. Additionally or alternatively, a container volume may be determined for each record 104a, and the container volume value 108 is then determined from the container volumes provided according to the individual records 104a. In certain embodiments, a most commonly occurring value is utilized for a container attribute (e.g., the greatest number of container attribute vote values 402 having a given value determine the container attribute). Additionally or alternatively, a median value, a mode value, a mean value, or other averaging mechanism is utilized to determine a container attribute from the container attribute vote values. Additionally or alternatively, a source quality value 404 is determined for one or more container attribute vote values 402, which may be utilized to give the related container attribute vote values 402 more or less weight (e.g., additional or reduced votes), to determine the value (e.g., where a high reliability value is determined), and/or to exclude the value (e.g., where a low reliability, questionable, impossible, or inapplicable value is determined).

An example container representation circuit 106 determines that no high confidence or high reliability container volume value 108 is established by the weighting operations. In a further example, the container representation circuit 106 determines a “best guess” estimate of the container volume value 108, for example utilizing values from other containers sharing one or more characteristics of the container, other data related to the container providing general information about the container (e.g., type of container, load weight and/or volume in the container, and/or default values according to industry standards, knowledge of industry practices, shipping information, shipping entities, etc.). An example container representation circuit 106 derives a container value from a modal value of containers known to exist, and/or from offset containers in the same or other records 104b. In certain embodiments, the container representation circuit 106 updates the “best guess” estimate, either in response to updated information providing a higher confidence or higher reliability container volume value 108, and/or from changes in the information providing the “best guess” estimate (e.g., a change in industry standards, and updated load weight or load volume held by the container in one or more records, etc.).

The description of the container representation circuit 106 determining the container volume value 108 is provided for convenient illustration. In certain embodiments, the container representation circuit 106 determines any characteristic for a container utilizing a weighting between shipment description values 202, and/or utilizing a “best guess” estimate as described in relation to the container volume value 108. Example and non-limiting container characteristics that may be determined by the container representation circuit 106 include, without limitation, a container equipment code, a container category identifier, and/or one or more container geometric dimensions. In certain embodiments, determined values for certain container characteristics by the container representation circuit 106 are utilized to determine other container characteristics by the container representation circuit 106—for example a determined geometric dimension may be utilized by the container representation circuit 106 in other operations to determine a container volume value 108.

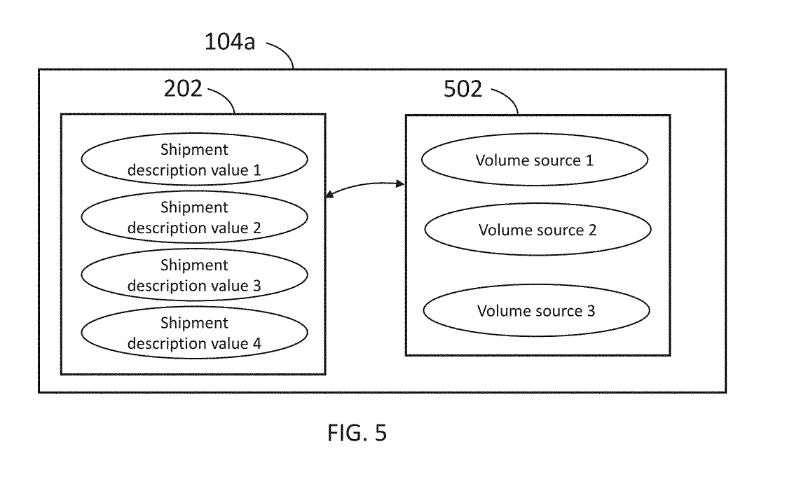

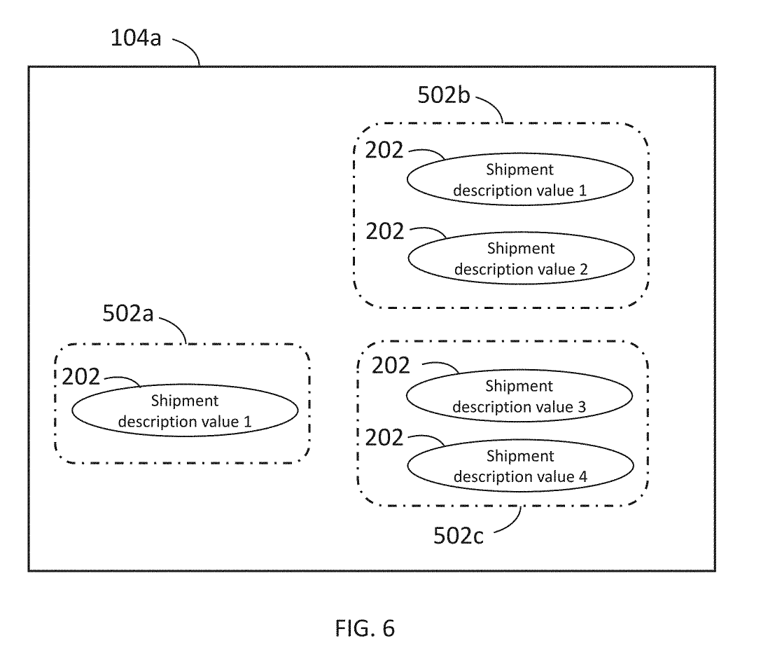

Referencing FIG. 5, an example container representation circuit 106 further determines the container volume value 108 in response to the weighting between the shipment description values by an operation such as: determining a container attribute vote value 402 corresponding to each of the records 104a and further in response to a highest source quality value from a number of volume sources 502 (generically depicted as “volume source 1” through “volume source 3”) within each of the records 104a; and/or selecting the container volume value 108 in response to the container attribute vote values 402 and corresponding source quality values 404. Example and non-limiting volume sources 502 in a record 104a include a geometry, a volume provided explicitly within a record 104a (e.g., “2 TEUs” where TEU is a twenty-foot equivalent, or standardized volume description), and/or a volume associated with one or more other parameters such as an equipment code or container type value. Referencing FIG. 6, a given volume source 502a, 502b, 502c within a record 104a may relate to one or more shipping description values 202, and shipping description values 202 may relate to one or more volume sources 502. Volume sources 502 may be determined explicitly in association with the record 104a, or determined at run-time and not otherwise associated with a record 104a.

An example container representation circuit 106 further determines the container volume value 108 in response to the weighting between the shipment description values by an operation such as: determining a container attribute vote value 402 corresponding to each of a plurality of volume sources 502 within each of the records 104a, and/or selecting the container volume value 108 in response to the container attribute vote values 402. In a further example, a container representation circuit 106 determines the container volume value 108 in response to the weighting between the shipment description values 202 by determining a source quality value 404 corresponding to each of the container attribute vote values 402, and further selecting the container volume value in response to the container attribute vote values 402. In certain embodiments, the container attribute vote values 402 are restricted to a discrete number of predetermined container attribute values—for example a length may be limited to a selected number of lengths corresponding to industry standard lengths for containers. A restricted container attribute vote value 402 may be held in run-time and then eliminated (e.g., the length used as the container attribute vote value 402 for the record 104a is used as the restricted value, but the underlying record 104a data is not changed), and/or the underlying record 104a data may be updated to the restricted container attribute vote value 402. In certain embodiments, the container attribute vote values 402 are determined as container volume vote values (e.g., each record 104a and/or volume source 502 “votes” for a container volume rather than a particular container attribute).

An example container representation circuit 106 further determines the container volume value 108 in response to the weighting between the shipment description values by utilizing, in order: container attribute vote values 402 corresponding to geometric description values; container attribute vote values 402 corresponding to equipment code values; and container attribute vote values 402 corresponding to equipment category identifier values. In certain embodiments, other container attribute vote values 402 are utilized, container attribute vote values are utilized in a different order, and/or certain ones of the listed container attribute vote values 402 are not considered. An example container representation circuit 106 further determines the container volume value 108 in response to the weighting between the shipment description values 202 by performing a rationalization operation on the container volume value 108. Example and non-limiting rationalization operations include limiting the container volume value 108 to standardized values, enforcing a minimum container volume value 108 (e.g., one-half TEU), enforcing a maximum container volume value 108 (e.g., two TEU, three TEU, or other context determined maximum), and/or applying an industry standard container volume value 108 (e.g., a most commonly occurring volume value according to a container type value).

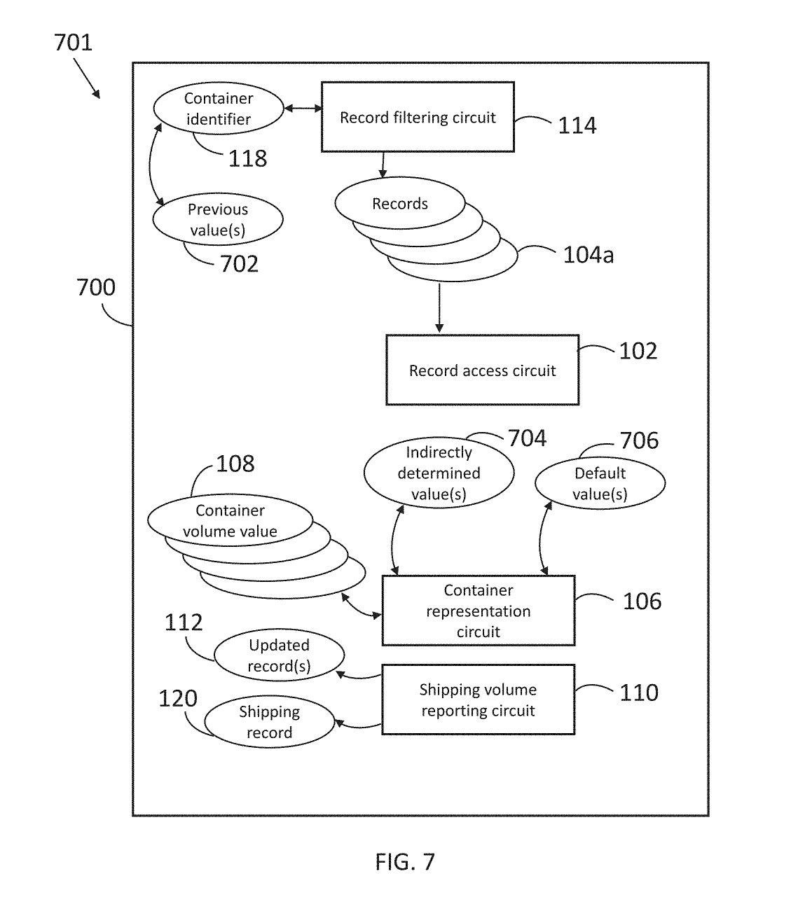

Referencing FIG. 7, a diagram 701 shows example system 700 including a container representation circuit 106 that further determines the container volume value 108 in response to the weighting between the shipment description values by utilizing at least one value selected from the values consisting of: a default container volume value 706, a previously utilized container volume value 702 corresponding to a container identifier 118 corresponding to records 104a, and/or an indirectly determined container volume value 704. An example operation to determine an indirectly determined container volume value 704 includes operations such as: a determination of a material type value and a shipping weight value of a shipment; and/or a volume correlation between a harmonized system (HS) code and a weight of the shipment. In certain embodiments, the container representation circuit 106 determines the container volume value 108 in response to determining a material type value (e.g., the type of material shipped) and a shipping weight value, and a volume correlation between a product category system and a weight of the shipment. The term “product category system” should be understood broadly, and includes any correlative information between a product weight and a product volume. Example and non-limiting product category system values include harmonized system (HS) codes (e.g., from which a density, bulk density, and/or loading characteristic of a product is determinable), chemical abstracts service (CAS) numbers (e.g., from which density, bulk density, and/or loading characteristic of a product is determinable), an industry specific code (e.g., an industry standard or agreed upon value referencing a product type), an entity specific code (e.g., a code utilized by the related entity on the shipping record allowing the identification of the product), an entity value (e.g., where a characteristic of the entity provides information about the volume, the weight, and/or other product information), a text description (e.g., a parse-able mention of product type, density, weight, volume, and/or other value from which the weight and/or volume of the shipment is determinable), a listed weight value, a port utilized (e.g., where the port provides information about the container, the product, or both), and/or a shipping vessel utilized (e.g., where the shipping vessel provides information about the container, the product, or both, and/or where an upstream or downstream vessel for the shipment provides information about the container).

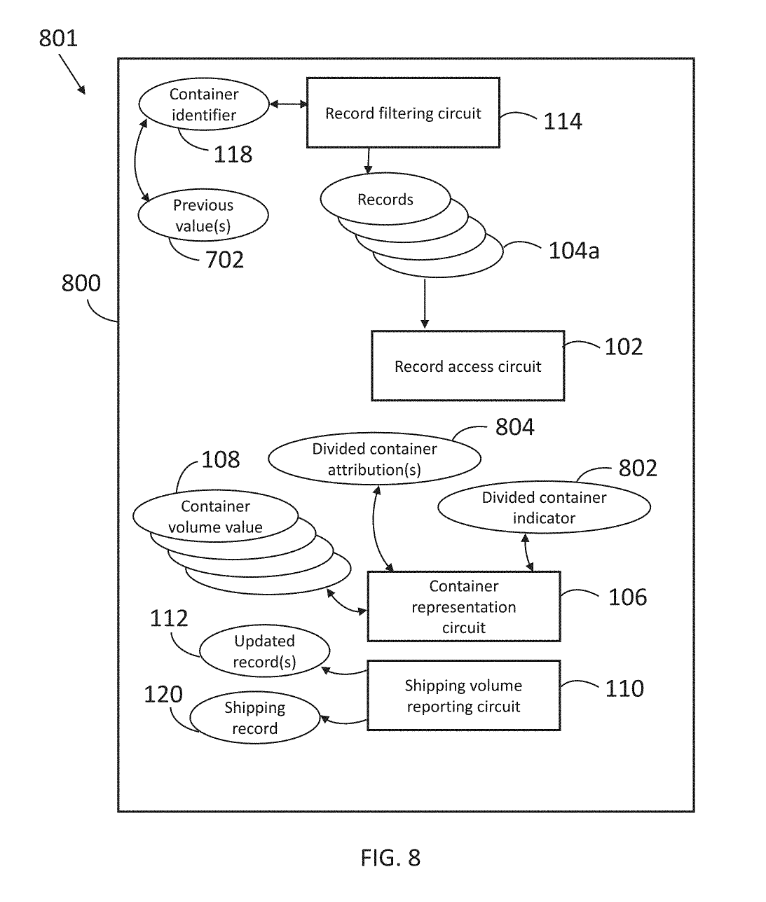

Referencing FIG. 8, a diagram 801 shows an example system 800 including a container representation circuit 106 that further determines that a container is divided (e.g., establishing a divided container indicator 802), and attributes a portion of the container volume value 108 to each of a number of the records 104a (e.g., determining that two records 104a share a container, and attributing a portion of the container to each record 104a, such as by establishing one or more divided container attributions 804). An example container representation circuit 106 further determines that a container is divided, and performs at least one operation such as: attributing a record count fraction of the records 104a associated with the divided container to each of a number of entities and/or transactions; attributing a weight value fraction of each the records 104a associated with the divided container; and/or attributing a volume fraction of each of the number of records 104a associated with the divided container.

Container volume values may be restricted to a discrete number of predetermined container volume values, including without limitation integer values of twenty-foot equivalent units (TEU) and/or half-integer values of twenty-foot equivalent units (TEU).

Referencing FIG. 9, a diagram 901 shows an example system 900 including a data integrity circuit 902 that performs an attribute cleanup operation on at least one shipping description value of one of the records 104b before the container representation circuit 106 determines the container attribute vote value 402 utilizing the at least one shipping description value 202. In certain embodiments, the data integrity circuit 902 provides cleaned record(s) 904 that are accessed by the record filtering circuit 114 and/or record access circuit 102. Example operations to perform an attribute cleanup include: determining an internal consistency of the at least one shipping description value 202 in response to other shipping description values 202 of the one of the records (e.g., determining the length as a sensible value in the context of the provided width and/or height); determining the at least one shipping description value 202 corresponds to a standardized value (e.g., correcting a length value to a standardized length value); determining the at least one shipping description value 202 includes at least one of an incorrect units value and an improperly converted units value (e.g., determining standard calculation and/or unit conversion error values, recognizing a predetermined error value is present, and utilizing a value that would have occurred if the calculation and/or unit conversion error had not occurred—for example recognizing cm values entered into a field that should have been inches, recognizing common errors in order of magnitude, utilizing common errors occurring in calculations to store recognizable erroneous values and corresponding correct values, etc.); determining the at least one shipping description value includes a predetermined error attribute; determining the at least one shipping value includes an extraneous character (and/or missing or transposed characters); and determining an external consistency of the at least one shipping description value in response to at least one of: other shipping description values 202 within the one of the records 104a; a same shipping description value 202 within a distinct one of the records 104a (e.g., determining that a length value is erroneously entered but a likely candidate for correction based on another record 104a utilizing the container); and/or other shipping description values 202 within a distinct one of the records (e.g., a length value is likely erroneous and a width value is missing, and borrowing a width value from another record 104a referencing the container to rationalize the length value for the current record 104a).

An example system 900 further includes an operation to adjust a weighting of the container attribute vote value 402 utilizing the at least one shipping description value 202 in response to a type of the attribute cleanup operation and a quantitative assessment of the attribute cleanup operation. For example, certain cleanup operations of the data integrity circuit 902 are understood to be reliable corrections (e.g., recognizing a calculation based on improper units through assessing the similarity of a stored result to one predicted through an improper unit calculation. The similarity and/or confidence may be based on, e.g., an exact similarity to several digits), and in certain embodiments the application of a reliable correction may not reduce the weight of the respective container attribute vote value 402 significantly or at all. In certain embodiments, the application of lower reliability corrections (e.g., utilizing default values or values from offset records 104a) may reduce the weight of the respective container attribute vote values 402 significantly and/or eliminate the respective container attribute vote values 402 from consideration entirely. The presence and quantity of other reliable data to determine the container volume value 108 may be utilized to determine the treatment and utilization of corrected data.

An example data integrity circuit 902 adjusts a weighting of at least one container attribute vote value 402 in response to at least one data quality indicator such as: a shipping description value source type (e.g., certain shipping description values 202 may be more reliable indicators of volume); an entity associated with the one of the records 104a including the shipping description value 202 utilized to determine the container attribute vote 402 (e.g., certain entities may be associated with more reliable data entry); a consistency indicator determined for the one of the records 104a including the shipping description value 202 utilized to determine the container attribute vote 402 (e.g., records 104a having fewer errors and/or more complete data may be associated with more reliability of the data within the record 104a); and/or a geography value corresponding to the one of the records including the shipping description value 202 utilized to determine the container attribute vote 402 (e.g., certain countries, ports, etc. may have different practices and regulations for data entry of certain fields of a record 104a).

An example container representation circuit 106 is further structured to adjust a change rate of at least one of a container attribute value or the container volume value 108 in response to an apparent rate of change of the container attribute value or the container volume value. For example, where a container attribute change indicates a type of change likely to occur (e.g., the value looks like an increased precision of a previous length value; a container type value changed simultaneously and consistently with a container code, etc.) the change may be allowed to occur instantaneously (e.g., the canonical representation of the container within the system is updated) and/or after just a few occurrences of the change. In another example, where a container attribute change indicates a type of change not likely to occur (e.g., the value of the attribute would indicate an unlikely physical change of the container, such as a categorical size increase) the change may be prevented and/or delayed until a significant number of occurrences of the container attribute change are present. The rate of change may reference the time delay in making the change, and in certain embodiments a change made to the canonical representation of a container occurs at a slow rate of change by being delayed (over time, a number of record 104a observations, etc.) and then being changed instantaneously after the delay. An example container representation circuit 106 further adjusts the change rate of at least one of a container attribute value or the container volume value by allowing a rapid change in response to at least one of: determining that an apparent change improves the precision of the at least one of the container attribute value or the container volume value; determining that an apparent change in the at least one of the container attribute value or the container volume value is indicated with high reliability; and/or determining that an apparent change in the at least one of the container attribute value or the container volume value reflects an actual change in a container corresponding to the at least one of the container number value or the container identifier.

An example container representation circuit 106 further adjusts the change rate of at least one of the container attribute value or the container volume value by slowing a change in response to at least one of: determining that an apparent change results in a categorical change in a container corresponding to at least one of the container number value or the container identifier; determining that an apparent change results in a changed container volume value corresponding to the container identifier; and/or determining that an apparent change in the at least one of the container attribute value or the container volume value reflects an actual change in a container corresponding to the at least one of the container number value or the container value, where the actual change is not supported in an available data set comprising the plurality of records.

An example container representation circuit 106 further excludes from consideration at least one of the records 104a in response to determining the one of the plurality of records does not represent data indicative of a physical container corresponding to at least one of the container number value or the container identifier 118. For example, where a container is deemed to have physically changed, and/or where two distinct containers are determined to be sharing the same container number, the canonical representations of those containers may be determined only from the records 104a determined to apply to each respective container. In certain embodiments, records 104a are not excluded from consideration, and a change is managed by the old inapplicable data for the container reducing in importance as the number of new records 104a having the updated data for the container grow over time.

An example shipping volume reporting circuit 110 further creates a shipping record 120 in response to the container volume value 108. The shipping record 120 includes any desired information, and may be updated examples of one or more records 104a having a shared container identifier 118, and/or may be other data of interest such as shipping volumes related to an entity, port, industry, or the like. An example shipping volume reporting circuit 110 further associates a container identifier 118 to the shipping record 120, and provides a number of container attribute values corresponding to the container identifier 118.

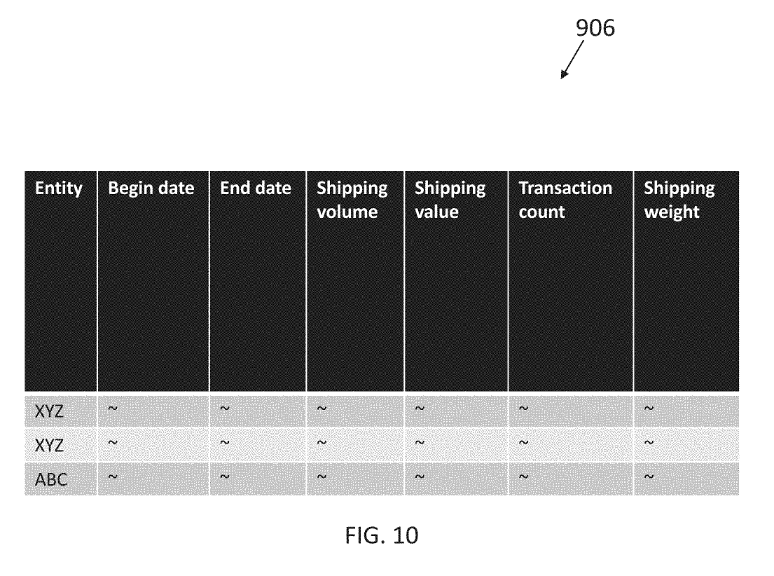

Referencing FIG. 10, an example shipping volume reporting circuit 110 further provides an aggregated shipping record 906 including an aggregated shipping value determined in response to the shipping records 120 (e.g., where shipping records 120 include records 104a of interest according to the criteria of the aggregated shipping record 906). Referencing FIG. 10, an example aggregated shipping record 906 includes an entity field, a date range (e.g., begin and end dates), a shipping volume (e.g., a summation of the associated container volume values 108), a transaction count (e.g., a number of transactions represented in the shipping records 120 of interest), and/or a shipping weight (e.g., a summation of the associated shipping weights in the shipping records 120 of interest). The example aggregated shipping record 906 is non-limiting, and any aggregation information of interest utilizing container volume values 108 associated with records 104a is contemplated herein. An example aggregated shipping record 906 includes an aggregation of the shipping records 120 corresponding to: an entity, a geographic location, a product type, a shipping vehicle, and/or at least one container identifier 118. An example aggregated shipping record 906 includes a volumetric description value.

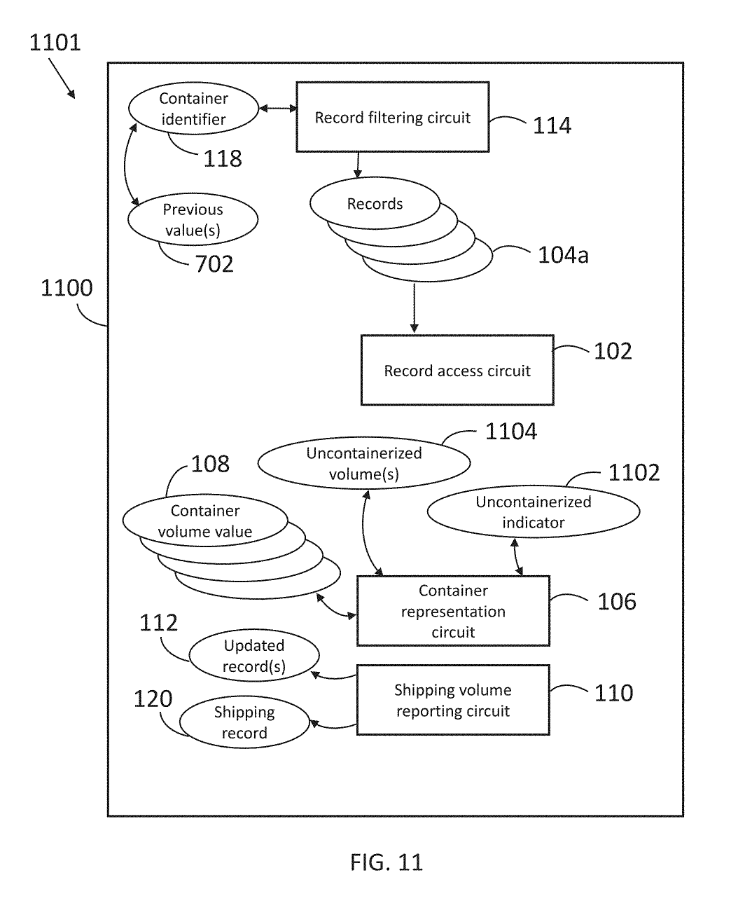

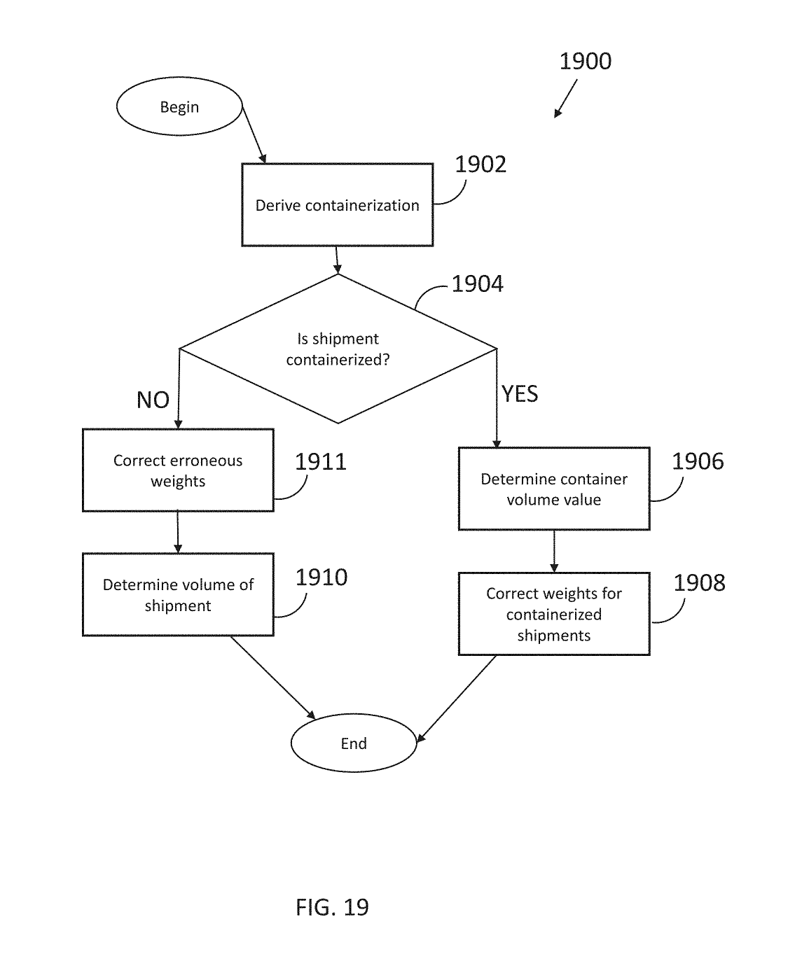

Referencing FIG. 11, a diagram 1101 shows an example system 1100 including a container representation circuit 106 determining that a record 104a is directed to an uncontainerized shipment (e.g., a bulk shipment such as grain or oil, etc.), for example setting an uncontainerized indicator 1102. In certain embodiments, volume descriptions for uncontainerized shipments are nevertheless valuable, and in certain embodiments utilizing a volume value comparable to containerized shipments is desirable (e.g., TEU). The container representation circuit 106 further determines an uncontainerized volume 1104 for the one or more records 104a—for example see operations described in the portion referencing FIG. 19. In certain embodiments, operations to determine a container volume for a containerized shipment may fail, and operations such as those described in regard to FIG. 19 and for uncontainerized shipments may additionally or alternatively be applied to containerized shipments to determine a container volume value 108 for such containerized shipments as well.

The following descriptions reference schematic flow diagrams and schematic flow descriptions for certain procedures and operations according to the present disclosure. Any such procedures and operations may be utilized with and/or performed by any systems of the present disclosure, and with other procedures and operations described throughout the present disclosure. Any groupings and ordering of operations are for convenience and clarity of description, and operations described may be omitted, re-ordered, grouped, and/or divided unless explicitly indicated otherwise.

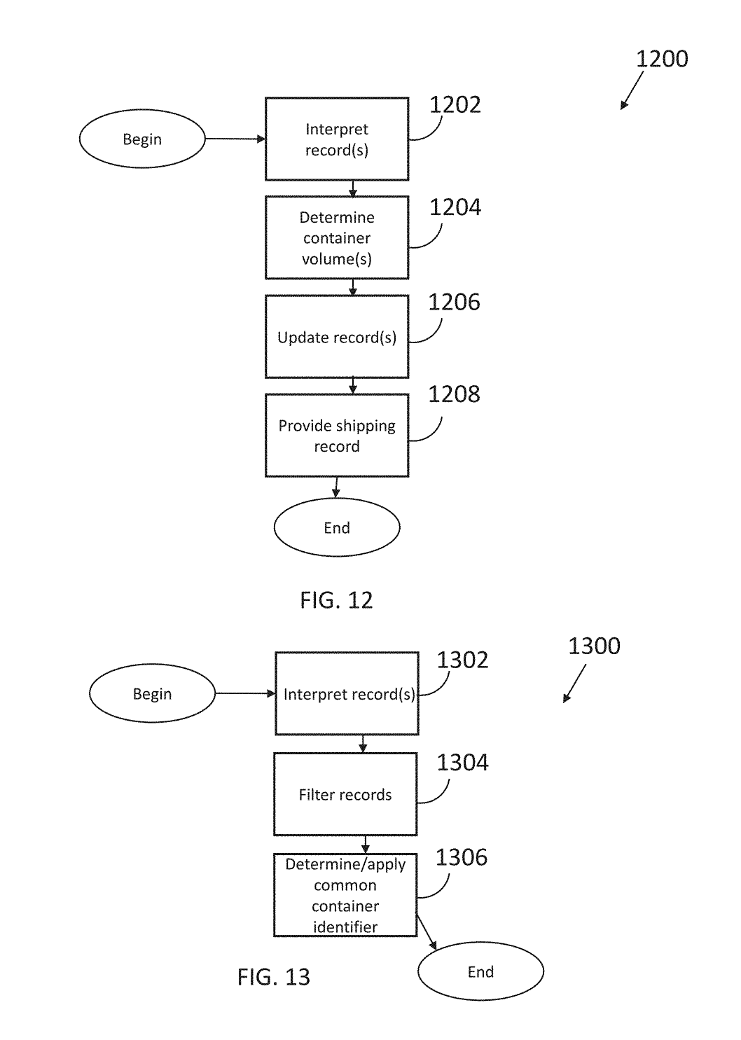

Referencing FIG. 12, an example procedure 1200 to determine a container volume and provide a shipping record made in response to the container volume is depicted. The procedure 1200 includes an operation 1202 to interpret a number of records, each of the records having a number of shipment description values, and an operation 1204 to determine a container volume value corresponding to each of the records, for example in response to a weighting between the shipment description values. The example procedure 1200 further includes an operation 1206 to update each of the records, and an operation 1208 to provide a shipping record, such as one or more updated records including the container volume value.

Referencing FIG. 13, an example procedure 1300 is depicted providing certain operations that can be performed during operation 1202 to interpret records, although the operations of the procedure in FIG. 13 may be performed in other contexts and with systems or procedures described throughout the present disclosure. The example procedure 1300 includes an operation 1302 to interpret a second number of records (e.g., full record set 116), where the second number of records include the number of records (e.g., records utilized in operation 1204 of FIG. 12), and an operation 1304 to filter the second plurality of records in response to a container identifier corresponding to each of the second plurality of records, and an operation 1306 to provide the records as a set of records having a common container identifier, for example by determining and/or applying a common container identifier to the records.

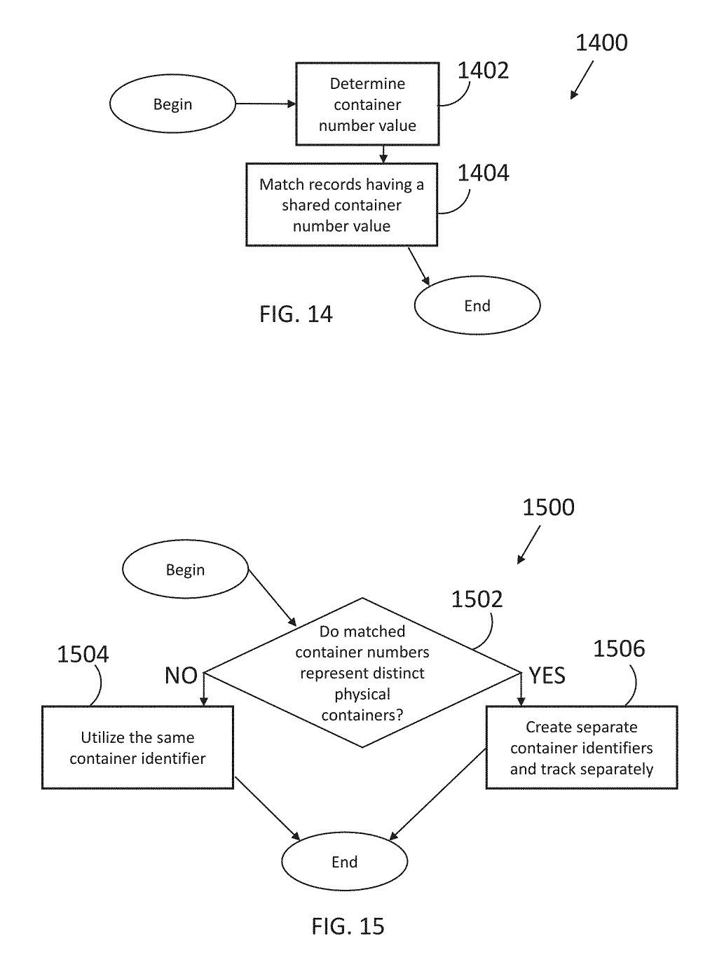

Referencing FIG. 14, an example procedure 1400 is depicted providing certain operations that can be performed during operation 1306 to determine a container identifier corresponding to each of the records in response to a container number value. An example procedure 1400 includes an operation 1402 to determine a container number value for each of the records, which may include a container number value as a data value, a corrected container number value, and/or a container number value determined from a container number clean-up operation for the record (e.g., as performed by a data integrity circuit 902). The example procedure 1400 further includes an operation 1404 to match records having a shared container number value (e.g., into a set of records 104a), for example by creating and/or applying a container identifier to the records and/or filtering the records into a set of records 104a.

Referencing FIG. 15, an example procedure 1500 is depicted providing certain operations that can be performed during operation 1404 to match records having a shared container number value, and/or to distinguish distinct physical containers having a shared container number value. The example procedure 1500 includes an operation 1502 to determine if records having matching container numbers represent distinct physical containers. Example operations 1502 include, without limitation, determining that records having a shared container number have consistently distinct shipping attributes (e.g., geometry descriptions, equipment type values, and/or equipment code values), and are consistently located in distinct geographical areas. The procedure 1500 further includes, in response to determining the records do not represent distinct physical containers, an operation 1504 to utilize the same container identifier for the records. The procedure 1500 further includes, in response to determining the records do represent distinct physical containers, an operation 1506 to create separate container identifiers for the records, and to track the records separately for volume determinations and other considerations.

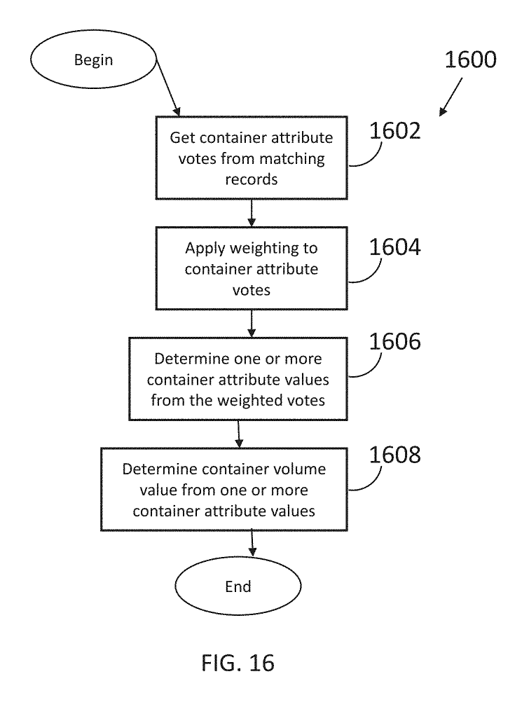

Referencing FIG. 16, an example procedure 1600 is depicted providing certain operations that can be performed during operation 1204 for determining the container volume value in response to the weighting between the shipment description values includes an operation 1602 to get container attribute vote values corresponding to each of the records, an operation 1604 to apply a weighting to container attribute votes from the records, an operation 1606 to determine one or more container attribute values for a canonical representation of the container (e.g., associated with the container identifier) from the weighted votes, and an operation 1608 to determine a container volume value for the container from one or more of the container attribute values. Accordingly, procedure 1600 can perform one or more operations such as: determining container attribute vote values corresponding to each of the records and selecting the container volume value in response to the container attribute vote values; determining a container attribute vote value corresponding to each of the records, and selecting the container volume value in response to the container attribute vote values according to the most commonly appearing container volume value; and/or determining a container attribute vote value corresponding to each of the records, determining a source quality value corresponding to each of the container attribute vote values, and selecting the container volume value in response to the container attribute vote values and corresponding source quality values.

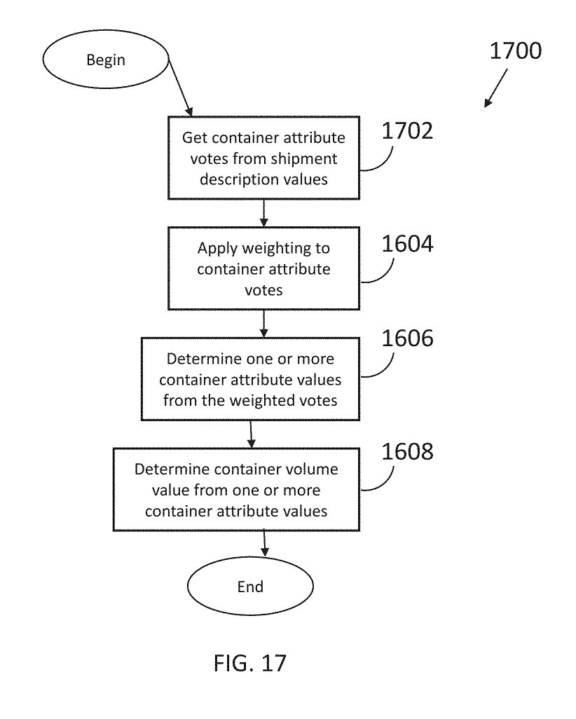

Referencing FIG. 17, an additional or alternative procedure 1700 is depicted providing certain operations that can be performed during operation 1204 for determining the container volume value in response to the weighting between the shipment description values includes an operation 1702 to get container attribute votes from shipment description values within records, and operations 1604, 1606, 1608 similar to those described in the disclosure referencing FIG. 16. Accordingly, procedure 1700 can perform one or more operations such as: determining a container attribute vote value corresponding to each of the records and further in response to a highest source quality value from a number of volume sources within each of the plurality of records; and selecting the container volume value in response to the container attribute vote values and corresponding source quality values. Example operations include determining the container volume value in response to the weighting between the shipment description values by operation 1702 determining a container attribute vote value corresponding to each of a number of volume sources within each of the records; and operation 1608 selecting the container volume value in response to the container attribute vote values.

An example operation further includes determining the container volume value in response to the weighting between the shipment description values by determining a source quality value corresponding to each of the container attribute vote values, and further selecting the container volume value in response to the container attribute vote values. Example operations include restricting the container attribute vote values to a discrete number of predetermined container attribute values. Example operations include the container attribute vote values being container volume vote values.

In certain operations, determining the container volume value in response to the weighting between the shipment description values includes performing operation, in order, to determine: container attribute vote values corresponding to geometric description values; container attribute vote values corresponding to equipment code values; and container attribute values corresponding to equipment category identifier values. In certain embodiments, where one of the ordered determinations generates a container volume value and/or a reliable container volume value, the remaining ordered determinations are omitted or skipped in determining the container volume value.

Example operations include determining the container volume value in response to the weighting between the shipment description values by performing a rationalization operation on the container volume value. Example operations include determining the container volume value in response to the weighting between the shipment description values by averaging a number of the container attribute vote values, where in certain embodiments the averaging includes utilizing a mode value from the number of container attribute vote values and/or utilizing a median value from the number of container attribute vote values. In certain embodiments, a first averaging method is utilized for certain ones of the container attribute vote values, and a second averaging method is utilized for other ones of the container attribute vote values.

Example operations further include determining the container volume value in response to the weighting between the shipment description values by utilizing at least one value such as: a default container volume value, a previously utilized container volume value corresponding to a container identifier corresponding to the plurality of records, and an indirectly determined container volume value. Example operations to indirectly determine the container volume value include: determining a material type value and a shipping weight value; and/or determining a volume correlation between a harmonized system (HS) code and a weight of the shipment.

Example operations include determining that a container is divided, and attributing a portion of the container volume value to each of a number of the records. Example operations further include determining that a container is divided, and performing at least one of the following operations in response to the divided container: attributing a record count fraction of the plurality of records associated with the divided container to each of a plurality of at least one of entities and transactions; attributing a weight value fraction of each the plurality of records associated with the divided container; and/or attributing a volume fraction of each of the plurality of records associated with the divided container.

Example operations include restricting the container volume value to a discrete number of predetermined container volume values. In certain further examples, the predetermined container volume values include integer values of twenty-foot equivalent units (TEU), half-integer, and/or quarter-integer values of twenty-foot equivalent units (TEU).

Example operations include performing an attribute cleanup operation on at least one shipping description value of one of the plurality of records before determining the container attribute vote value utilizing the at least one shipping description value. Example and non-limiting attribute cleanup operations include operations such as: determining an internal consistency of the at least one shipping description value in response to other shipping description values of the one of the plurality of records; determining the at least one shipping description value corresponds to a standardized value; determining the at least one shipping description value includes at least one of an incorrect units value and an improperly converted units value; determining the at least one shipping description value includes a predetermined error attribute; determining the at least one shipping value includes an extraneous character; and/or determining an external consistency of the at least one shipping description value. Example operations to determine an external consistency of the shipping description value(s) include: utilizing other shipping description values within the record; utilizing a same shipping description value within a distinct one of the records; and/or utilizing other shipping description values within a distinct one of the records.

Example operations include adjusting a weighting of the container attribute vote value utilizing the at least one shipping description value in response to at least one of a type of the attribute cleanup operation and a quantitative assessment of the attribute cleanup operation. Certain operations to adjust the weighting of at least one of the container attribute vote values in response to at least one data quality indicator such as: a shipping description value source type; an entity associated with the one of the records including the shipping description value utilized to determine the container attribute vote; a consistency indicator determined for the one of the records including the shipping description value utilized to determine the container attribute vote; a geography value corresponding to the record including the shipping description value utilized to determine the container attribute vote; and/or combinations of the foregoing.

Example operations include adjusting a change rate of at least one of a container attribute value or the container volume value in response to an apparent rate of change of the container attribute value or the container volume value. Example operations to adjust a change rate include allowing a rapid change in response to at least one of: determining that an apparent change improves the precision of the at least one of the container attribute value or the container volume value; determining that an apparent change in the at least one of the container attribute value or the container volume value is indicated with high reliability; and/or determining that an apparent change in the at least one of the container attribute value or the container volume value reflects an actual change in a container corresponding to the container number value and/or the container identifier. Certain additional or alternative operations to adjust the change rate include adjusting the change rate of at least one of the container attribute value or the container volume value by slowing a change in response to: determining that an apparent change results in a categorical change in a container corresponding to at least one of the container number value or the container identifier; determining that an apparent change results in a changed container volume value corresponding to the container identifier; and/or determining that an apparent change in the container attribute value and/or the container volume value reflects an actual change in a container corresponding to the at least one of the container number value or the container value, where the actual change is not supported in an available data set comprising the plurality of records. For example, where a container is indicated as changed in only one or a few records, but later records are consistent with earlier records indicating that no change has occurred, the actual change may be deemed to be not supported in the available data set.

An example operation includes excluding from consideration at least one of the records in response to determining the one of the records does not represent data indicative of a physical container corresponding to at least one of the container number value or the container identifier.

Example operations include creating a shipping record in response to the container volume value, associating a container identifier to the shipping record, and/or providing a number of container attribute values corresponding to the container identifier in the shipping record. In certain embodiments, operations include providing an aggregated shipping record including an aggregated shipping value determined in response to a number of the shipping records. Example and non-limiting aggregated shipping records include an aggregation of the shipping records corresponding to: an entity, a geographic location, a product type, a shipping vehicle, and/or at least one container identifier. An example aggregated shipping record includes a volumetric description value.

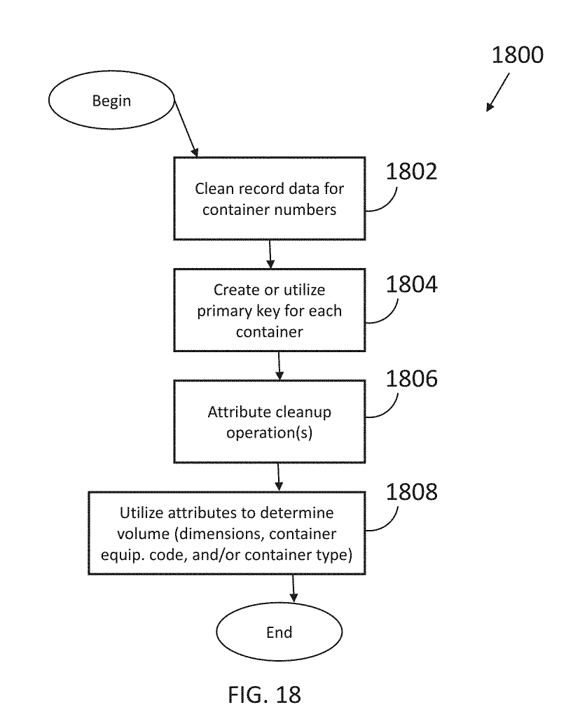

Referencing FIG. 18, an example procedure 1800 for determining a container volume value includes an operation 1802 to clean record data for container numbers (e.g., performed by a data integrity circuit 902), an operation 1804 to create or utilize a primary key for each container 1804, an operation 1806 to clean record data for container attribute values and/or shipping description values (e.g., performed by the data integrity circuit 902), and an operation 1808 to utilize container attribute values to determine the container volume value (including, for example, dimensions, container equipment code, and/or container type).

Referencing FIG. 19, an example procedure 1900 for determining a container volume value includes an operation 1902 to derive containerization (e.g., whether the record indicates the shipment is in a container or not in a container). In response to a determination 1904 that the shipment is containerized, procedure 1900 further includes an operation 1906 to determine a container volume value (e.g., by any systems or procedures described throughout the present disclosure), and a procedure 1908 to correct a weight for a containerized shipment (e.g., the record indicates a containerized shipment of a certain product type, and weight information in the record is erroneous such as might occur with an order of magnitude error, incorrect entry of data into the wrong field, and/or an incorrect units error) and providing the shipping record with the corrected weight value. The volume of the container and number of containers associated with a given shipment record, in certain embodiments, are utilized to determine the weight values that are reasonably associated with the containerized shipment.

In response to the determination 1904 that the shipment is not containerized, the procedure 1900 includes an operation 1911 to correct erroneous weights (e.g., utilizing one or more operations such as described in reference to operation 1908), and a procedure 1910 to determine a volume of the shipment (e.g., by any systems or procedures described throughout the present disclosure), for example enabling comparison of shipments, and/or useful aggregation of shipping data.

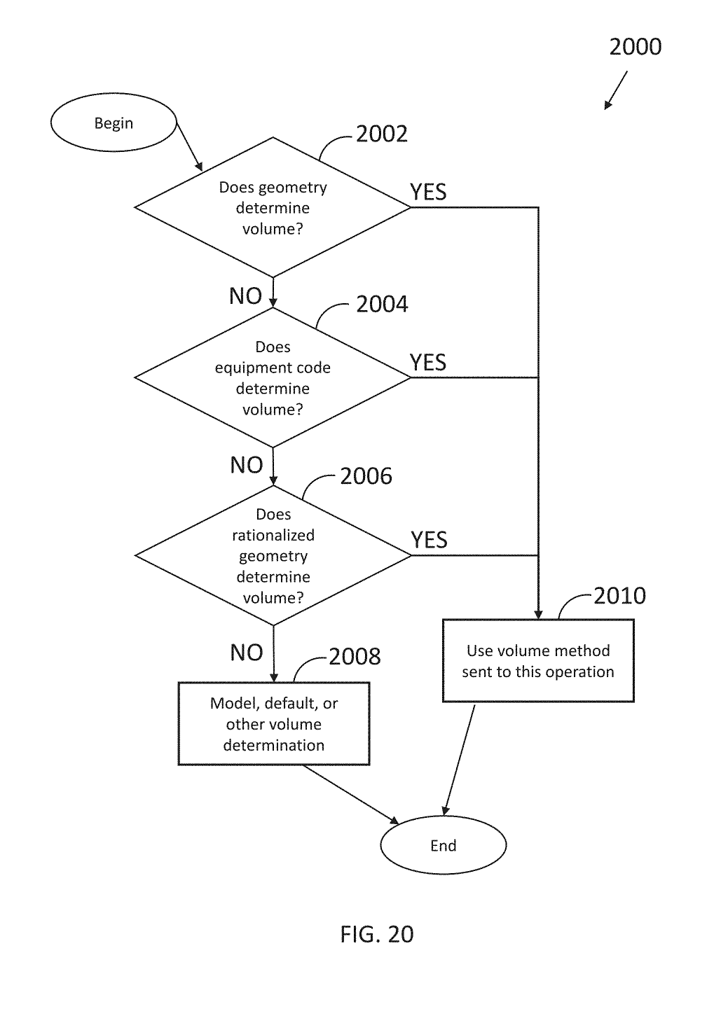

Referencing FIG. 20, an additional or alternative procedure 2000 is depicted providing certain operations that can be performed during operation 1808 for utilizing container attribute values to determine a container volume value is depicted. The procedure 2000 includes an operation 2002 to determine whether geometry description values (e.g., length, width, and/or height) determine a container volume value and/or an acceptably reliable container volume value. In response to the operation 2002 determining the geometry description values do not determine a container volume value and/or an acceptably reliable container volume value, the procedure 2000 further includes an operation 2004 to determine whether equipment code values (e.g., equipment codes and/or container type values) determine a container volume value and/or an acceptably reliable container volume value. In response to determining that the equipment code values do not determine a container volume value and/or an acceptably reliable container volume value, the procedure 2000 further includes an operation 2006 to determine whether a rationalized geometry determines a container volume value and/or an acceptably reliable container volume value. Examples of a rationalized geometry value include, without limitation, a standard container size for the type of shipment, shipping vessel, and/or shipping entity, a capped sizing value (e.g., a minimum or maximum size applied to the geometry description values), and/or a standard container size for the type of goods being shipped. In response to the operation 2006 determining that the rationalized geometry has not determined a container volume value and/or an acceptably reliable container volume value, the procedure includes an operation 2008 to model the volume, utilize a default volume, or make another volume determination. Example operations 2008 include utilizing a common standard container size (e.g., 2 TEU), determining an amount of goods and utilizing a correlation (e.g., utilizing an HS code) to estimate the container volume value, and/or utilizing a container volume value in response to other containers on a shipping vessel with the container being determined. In response to any of the operations 2002, 2004, 2006 determining a container volume value and/or an acceptably reliable container volume value, the procedure 2000 includes an operation 2010 to utilize the volume from the originating operations 2002, 2004, 2006 for the container volume value.

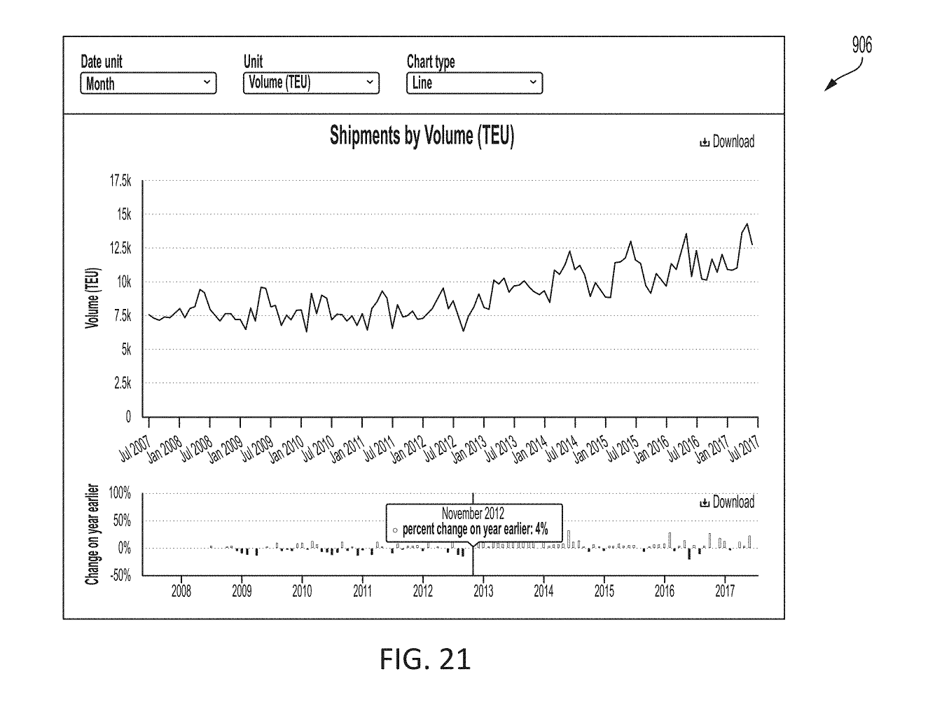

Referencing FIG. 21, an example illustrative aggregated shipping record 906 is depicted, for example as shipping over time, shipping for a given entity, shipping for a given port, shipping for a given product time, shipping from one or more selected destinations, and/or combinations of these. The example aggregated shipping record 906 depicts shipping volumes over time according to selected criteria (e.g., dates) and for a selected entity, port, geography, group of containers, etc. The aggregated shipping record 906 is depicted in an interactive format, where a user can change the time frames (e.g., monthly versus daily, seasonal, etc.), units depicted, and the type of chart output. Additionally or alternatively, a user can select the source data, the type of output, and/or the output format (not shown). The aggregated shipping record 906 additionally depicts a change value from a prior year. The change data is subject to large variations in response to small accuracy errors, and accordingly any decision making on such data is enhanced by an enhanced accuracy of the volume determinations. In certain embodiments, regularization and smoothing from volume derivation integrating data from multiple shipments improves the accuracy of volume determinations (or other aggregated container data). In certain embodiments, volume derivation integrating data from data beyond the specific time series (or other aggregating dimension) improves the accuracy within the specific time series data. Additionally or alternatively, limits to specific characteristics (e.g., volume data) within the specific time series data, and/or related aspects of determining the specific characteristics (e.g., error corrections, rationality checks, and/or replacement of outlier data with reasonable estimates) improve the accuracy within the specific time series data.

The illustrative aggregated shipping record 906 is a non-limiting example to illustrate certain operations of the systems and procedures described throughout the present disclosure. In certain embodiments, the container volume values, shipping records, and/or aggregated shipping records determined herein provide a baseline assessment for a user to compare scenarios for shipping information, check sensitivity of data to errors or incomplete information within data sets, to check data for shipping information from other sources, and/or as an extra data set as an input to determining actual values for shipping information. In certain embodiments, volumetric data is less sensitive than other measures (e.g., weight or value) for determining capacities, manufacturing, and shipping of small products, and provides a standard measure of comparison to detect or mitigate data more sensitive to outliers or data errors (e.g., weights). Additionally, volumetric data provides a better indicator of trade flow than other measures such as record or transaction counts, which can vary significantly in scale. This variation can occur based around filing patterns (e.g., many records filed for a low physical volume or weight of shipment) or for other reasons. In certain embodiments, the previously unknown use of historical data from records that may not be of specific interest in understanding current shipping volumes, creates greater confidence and more rapid convergence on determinations of container volume values.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g., where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are contemplated in embodiments of the present disclosure.

Comprise, include, and/or plural forms of each are open ended and include the listed parts and can include additional parts that are not listed. And/or is open ended and includes one or more of the listed parts and combinations of the listed parts.

Variations, modifications, and other implementations of what is described herein will occur to those of ordinary skill in the art without departing from the spirit and the scope of the invention. Accordingly, the invention is not to be limited only to the preceding illustrative descriptions.

1. A system, comprising:
a record access circuit structured to interpret a plurality of records, each of the records comprising a plurality of shipment description values;
a container representation circuit structured to determine a container volume value corresponding to each of the plurality of records, wherein the container representation circuit is further structured to determine the container volume value in response to a weighting between the shipment description values; and
a shipping volume reporting circuit structured to update each of the plurality of records with the container volume value.

2. The system of claim 1, further comprising a record filtering circuit structured to interpret a second plurality of records, wherein the second plurality of records comprises the plurality of records, to filter the second plurality of records in response to a container identifier corresponding to each of the second plurality of records, and to provide the plurality of records to the record access circuit as a set of records having a common container identifier.

3. The system of claim 2, wherein the container identifier comprises a primary key for a container.

4. The system of claim 2, wherein the record filtering circuit is further structured to determine the container identifier corresponding to each of the second plurality of records in response to at least one value selected from the values consisting of: a container number value, a corrected container number value, and a container number value determined from a container number clean-up operation.

5. The system of claim 2, further comprising determining that a first container having a first container number value identical to a second container having a second container number value is a distinct physical container, and providing a first container identifier for the first container and a second container identifier for the second container.

6. The system of claim 1, wherein the shipment description values comprise at least one value selected from the values consisting of: a geometric description value, an equipment code value, a container category identifier, and a previously known value for any of the preceding corresponding to the container identifier.

7. The system of claim 1, wherein the container representation circuit is further structured to determine the container volume value in response to the weighting between the shipment description values by performing at least one operation selected from the operations selected from:
determining a container attribute vote value corresponding to each of the plurality of records, and selecting the container volume value in response to the container attribute vote values;
determining a container attribute vote value corresponding to each of the plurality of records, and selecting the container volume value in response to the container attribute vote values according to the most commonly appearing container volume value; and
determining a container attribute vote value corresponding to each of the plurality of records, determining a source quality value corresponding to each of the container attribute vote values, and selecting the container volume value in response to the container attribute vote values and corresponding source quality values.

8. The system of claim 1, wherein the container representation circuit is further structured to determine the container volume value in response to the weighting between the shipment description values by:
determining a container attribute vote value corresponding to each of the plurality of records and further in response to a highest source quality value from a plurality of volume sources within each of the plurality of records; and
selecting the container volume value in response to the container attribute vote values and corresponding source quality values.

9. The system of claim 1, wherein the container representation circuit is further structured to determine the container volume value in response to the weighting between the shipment description values by:
determining a container attribute vote value corresponding to each of a plurality of volume sources within each of the plurality of records; and
selecting the container volume value in response to the container attribute vote values.

10. The system of claim 9, wherein the container representation circuit is further structured to determine the container volume value in response to the weighting between the shipment description values by determining a source quality value corresponding to each of the container attribute vote values, and further selecting the container volume value in response to the container attribute vote values.

11.-13. (canceled)

14. The system of claim 1, wherein the container representation circuit is further structured to determine the container volume value in response to the weighting between the shipment description values by performing a rationalization operation on the container volume value.

15. The system of claim 14, wherein the container representation circuit is further structured to determine the container volume value in response to the weighting between the shipment description values by averaging a plurality of the container attribute vote values.

16.-17. (canceled)

18. The system of claim 1, wherein the container representation circuit is further structured to determine an indirectly determined container volume value by performing at least one operation selected from the operations consisting of:
a determination of a material type value and a shipping weight value; and
a volume correlation between a product category system and a weight of the shipment.

19.-20. (canceled)

21. The system of claim 1, wherein the container representation circuit is further structured to determine that a container is divided, and to perform at least one of the following operations in response to the divided container:
attribute a record count fraction of the plurality of records associated with the divided container to each of a plurality of at least one of entities and transactions;
attribute a weight value fraction of each the plurality of records associated with the divided container; and
attribute a volume fraction of each of the plurality of records associated with the divided container.

22.-24. (canceled)

25. The system of claim 1, further comprising a data integrity circuit structured to perform an attribute cleanup operation on at least one shipping description value of one of the plurality of records before determining the container attribute vote value utilizing the at least one shipping description value.

26. The system of claim 25, wherein the attribute cleanup operation comprises at least one operation selected from:
determining an internal consistency of the at least one shipping description value in response to other shipping description values of the one of the plurality of records;
determining the at least one shipping description value corresponds to a standardized value;
determining the at least one shipping description value includes at least one of an incorrect units value and an improperly converted units value;
determining the at least one shipping description value includes a predetermined error attribute;
determining the at least one shipping value includes an extraneous character; and
determining an external consistency of the at least one shipping description value in response to at least one of: other shipping description values within the one of the plurality of records; a same shipping description value within a distinct one of the plurality of records; and other shipping description values within a distinct one of the plurality of records.

27. The system of claim 26, further comprising adjusting a weighting of the container attribute vote value utilizing the at least one shipping description value in response to at least one of a type of the attribute cleanup operation and a quantitative assessment of the attribute cleanup operation.

28. The system of claim 1, further comprising a data integrity circuit structured to adjust a weighting of at least one of the container attribute vote values in response to at least one data quality indicator selected from the data quality indicators consisting of:
a shipping description value source type;
an entity associated with the one of the plurality of records including the shipping description value utilized to determine the container attribute vote;
a consistency indicator determined for the one of the plurality of records including the shipping description value utilized to determine the container attribute vote;
a geography value corresponding to the one of the plurality of records including the shipping description value utilized to determine the container attribute vote; and
combinations of the foregoing.

29. The system of claim 1, wherein the container representation circuit is further structured to adjust a change rate of at least one of a container attribute value or the container volume value in response to an apparent rate of change of the container attribute value or the container volume value.

30. The system of claim 29, wherein the container representation circuit is further structured to adjust the change rate of at least one of a container attribute value or the container volume value by allowing a rapid change in response to at least one of:
determining that an apparent change improves the precision of the at least one of the container attribute value or the container volume value;
determining that an apparent change in the at least one of the container attribute value or the container volume value is indicated with high reliability; and
determining that an apparent change in the at least one of the container attribute value or the container volume value reflects an actual change in a container corresponding to the at least one of the container number value or the container identifier.

31. The system of claim 29, wherein the container representation circuit is further structured to adjust the change rate of at least one of the container attribute value or the container volume value by slowing a change in response to at least one of:
determining that an apparent change results in a categorical change in a container corresponding to at least one of the container number value or the container identifier;
determining that an apparent change results in a changed container volume value corresponding to the container identifier; and
determining that an apparent change in the at least one of the container attribute value or the container volume value reflects an actual change in a container corresponding to the at least one of the container number value or the container value, where the actual change is not supported in an available data set comprising the plurality of records.

32. The system of claim 1, wherein the container representation circuit is further structured to exclude consideration for at least one of the plurality of records in response to determining the one of the plurality of records does not represent data indicative of a physical container corresponding to at least one of the container number value or the container identifier.

33. The system of claim 1, wherein the shipping volume reporting circuit is further structured to create or amend a shipping record in response to the update to the container volume value.

34. The system of claim 33, wherein the shipping volume reporting circuit is further structured to associate a container identifier to the shipping record, and to provide a plurality of container attribute values corresponding to the container identifier.

35. The system of claim 34, wherein the shipping volume reporting circuit is further structured to provide an aggregated shipping record comprising an aggregated shipping value determined in response to a plurality of the shipping records.

36.-73. (canceled)
